(19) United States
(12) Patent Application Publication
(10) Pub. No.: US 2025/0123471 A1
(43) Pub. Date: Apr. 17, 2025

(54) OPTICAL SYSTEM, OPTICAL MODULE, AND LIDAR DEVICE

(71) Applicant: NINGBO SUNNY AUTOMOTIVE OPTECH CO., LTD., Ningbo City (CN)

(72) Inventors: Jia YANG, Ningbo City (CN); Chao XU, Ningbo City (CN); Xiang LI, Ningbo City (CN); Qirui GUAN, Ningbo City (CN)

(21) Appl. No.: 18/989,968

(22) Filed: Dec. 20, 2024

Related U.S. Application Data
(63) Continuation of application No. PCT/CN2024/103964, filed on Jul. 5, 2024.

(30) Foreign Application Priority Data
May 5, 2023 (CN) 202310511795.1
May 30, 2023 (CN) 202310629929.X
May 31, 2023 (CN) 202310639495.1

(51) Int. Cl. G02B 13/18; G01S 7/481; G02B 3/04

(52) U.S. Cl. CPC G02B 13/18; G01S 7/4816; G02B 3/04

(57) ABSTRACT

An optical system, an optical module, and a LiDAR device are provided. The optical system includes: a lens group, arranged sequentially along an optical axis from an object side to an image side; and an optical element, disposed on a transmission optical path of the lens group, the optical element having different focal lengths in a first direction and a second direction; where the first direction and the second direction have an included angle therebetween and are both perpendicular to the optical axis, and a focal length of the optical system in the first direction is different from a focal length of the optical system in the second direction.

### CROSS-REFERENCE TO RELATED APPLICATIONS

This patent application is a continuation of International application No. PCT/CN2024/103964, filed on Jul. 5, 2024, which claims the priority from Chinese Patent Application No. 202310511795.1, filed on May 5, 2023 and titled “Optical System and Lidar Device”, Chinese Patent Application No. 202310629929.X, filed on May 30, 2023 and titled “Optical System, Optical Module and Mounting Method thereof”, and Chinese Patent Application No. 202310639495.1, filed on May 31, 2023 and titled “Optical System and Optical Module”, All of the aforementioned applications are hereby incorporated by reference in their entireties.

### TECHNICAL FIELD

The present disclosure relates to the technical field of optical element, in particular to an optical system, an optical module, and a LiDAR device.

### BACKGROUND

The camera module is an essential component in machine vision systems and is widely used in many fields. For instance, it is utilized in reversing image, 360° panoramic views or autonomous driving assistance in the automotive sector, as well as in lidar detection.

The camera module typically includes an optical lens and a photosensitive chip. The photosensitive chip is positioned at the imaging plane of the optical lens, and light from the outside forms a spot after passing through the lens and illuminates the chip. The photosensitive chip then converts the received light spot into an electrical signal. In related technologies, the optical lens is generally composed of multiple spherical or aspherical lenses spaced along the optical axis. The lenses are usually symmetrical about the optical axis center, such as being circular, so that the external light forms a circular spot after passing through the lens. However, some photosensitive chips are rectangular or elliptical, and along the length of the chip, the circular spot only illuminates a partial photosensitive area of the chip, leaving the remaining area without light reception, which results in a waste of photosensitive area.

### SUMMARY

An optical system, an optical module and a LiDAR device provided by embodiments of the present disclosure may address or partially address the above deficiencies in the existing technology or other deficiencies in the existing technology.

An optical system according to an embodiment of a first aspect of the present disclosure, includes: a lens group, arranged sequentially along an optical axis from an object side to an image side; and an optical element, disposed on a transmission optical path of the lens group, the optical element having different focal lengths in a first direction and a second direction; where the first direction and the second direction have an included angle therebetween and are both perpendicular to the optical axis, a focal length of the optical system in the first direction is different from a focal length of the optical system in the second direction.

An optical system according to an embodiment of a second aspect of the present disclosure, includes: a lens group, arranged sequentially along an optical axis from an object side to an image side; at least one of multiple lenses being a free-form surface lens; where an optical parameter of the free-form surface lens in a first direction satisfies a preset condition, such that a focal length of the optical system in the first direction is smaller than a focal length of the optical system in a second direction, and the first direction and the second direction have an included angle therebetween and are both perpendicular to the optical axis.

According to an embodiment of the disclosure, the free-form lens is a lens closer to the image side, and the image-side surface of the free-form lens is a free-form surface.

According to an embodiment of the disclosure, the optical parameters include the radius of curvature of the free-form surface, and the preset conditions includes the radius of curvature Ry of the free-form surface along the first direction and the radius of curvature Rx of the free-form surface along the second direction, satisfying: |Ry/Rx|≥1.02.

According to an embodiment of the disclosure, the optical parameters include the radius of curvature of the free-form surface, and the preset conditions include the radius of curvature Ry of the free-form surface along the first direction and the focal length Fy0 of the optical system along the first direction, satisfying: Ry/Fy0≤1.

According to an embodiment of the disclosure, the optical parameters include the focal length, and the preset conditions include the focal length Fy1 of the free-form lens along the first direction and the focal length Fy0 of the optical system along the first direction, satisfying: |Fy1/Fy0|≥0.5.

According to an embodiment of the disclosure, the optical parameters include the focal length, and the preset conditions include the focal length Fy1 of the free-form lens along the first direction and the focal length Fx1 of the free-form lens along the second direction, satisfying: 1.003≤Fx1/Fy1.

According to an embodiment of the disclosure, the focal length Fy0 of the optical system along the first direction and the focal length Fx0 of the optical system along the second direction satisfy: Fx0/Fy0≥1.005.

According to an embodiment of the disclosure, the maximum effective aperture D of the optical system, the distance L between the center of the free-form surface and the center of the imaging plane of the optical system, and the image height H corresponding to the maximum field of view of the optical system satisfy: D*L/H≥5.

According to an embodiment of the disclosure, the focal length F of an optical system and the entrance pupil diameter ENPD of the optical system satisfy: F/ENPD≤1.8.

According to an embodiment of the disclosure, the distance L between the center of the free-form surface and the center of the imaging plane of an optical system, and the total track length TTL of the optical system satisfy the condition: L/TTL≥0.1.

According to an embodiment of the disclosure, the total track length TTL of the optical system, the maximum field of view FOV of the optical system, and the image height H corresponding to the maximum field of view of the optical system satisfy: TTL/H/FOV≤0.3.

According to an embodiment of the disclosure, the total track length TTL of the optical system, the sag SAGy of the free-form surface along the first direction, and the sag SAGx of the free-form surface along the second direction satisfy: TTL/[(SAGx+SAGy)/2]≥40.

According to an embodiment of the disclosure, the distance L between the center of the free-form surface and the center of the imaging plane of the optical system, and the focal length Fx0 of the optical system along the second direction satisfy the condition: 0.2≤L/Fx0≤1.

An optical system according to an embodiment in a third aspect of the present disclosure, from a light incidence side to a light exit side sequentially includes: a lens group and a cylindrical lens, at least one of a surface of the cylindrical lens facing the lens group and a surface of the cylindrical lens facing away from the lens group is a cylindrical surface, such that light passing through the cylindrical lens have different focal lengths in an X-axis direction and a Y-axis direction; where the X-axis direction includes a direction perpendicular to a direction of an optical axis of the lens group, and the Y-axis direction includes a direction perpendicular to both the direction of the optical axis and the X-axis direction.

According to an embodiment of the disclosure, the cylindrical lens is a convex cylindrical lens.

According to an embodiment of the disclosure, the cylindrical lens forms a convex surface in the Y-axis direction.

According to an embodiment of the disclosure, the cylindrical lens includes the plano-convex cylindrical lens or the biconvex cylindrical lens.

According to an embodiment of the disclosure, the convex cylindrical lens is a plano-convex cylindrical lens, where the convex surface of the plano-convex cylindrical lens faces away from the lens group.

According to an embodiment of the disclosure, the radius of curvature R of the side surface of the convex cylindrical lens facing away from the lens group in the Y-axis direction and the focal length Fy0 of the optical system in the Y-axis direction satisfy: R/Fy0≤−5.

According to an embodiment of the disclosure, the curvature radius R of the convex surface of the convex cylindrical lens in the Y-axis direction and the focal length Fy0 of the optical system in the Y-axis direction satisfy the relationship: |R/Fy0|≥5.

According to an embodiment of the disclosure, the focal length Fy1 of the cylindrical lens in the Y-axis direction, the focal length Fy2 of the lens group in the Y-axis direction, and the distance d on the optical axis of the optical system from the center of the side surface of the cylindrical lens closer to the lens group to the center of the side surface of the last lens in the lens group closer to the cylindrical lens satisfy: Fy2/(Fy1*\sqrt{d})≥0.005.

According to an embodiment of the disclosure, the focal length Fy1 of the cylindrical lens in the Y-axis direction and the focal length Fy2 of the lens group in the Y-axis direction satisfy: |Fy1/Fy2|≥10.

According to an embodiment of the disclosure, the focal length Fx0 of the optical system in the X-axis direction and the focal length Fy0 in the Y-axis direction satisfy: Fx0/Fy0≥1.002.

According to an embodiment of the disclosure, the optical system further includes: a photosensitive component disposed on the side of the cylindrical lens facing away from the lens group.

According to an embodiment of the disclosure, the direction of the Y-axis is parallel to the extension direction of the long side of the photosensitive area of the photosensitive component.

According to an embodiment of the disclosure, the maximum effective aperture D of the optical system, the image height H corresponding to the maximum field of view of the optical system, and the distance L from the center of the side surface of the cylindrical lens facing away from the lens group to the center of the imaging plane of the optical system along the optical axis of the optical system satisfy: D*L/H≥5 mm.

According to an embodiment of the disclosure, the X-axis focal length Fx0 of the optical system and the entrance pupil diameter ENPD satisfy: Fx0/ENPD≤2.

According to an embodiment of the disclosure, the distance L from the center of the side surface of the cylindrical lens facing away from the lens group to the center of the imaging plane of the optical system along the optical axis of the optical system, and the distance TTL from the center of the side surface of the lens group facing away from the cylindrical lens to the imaging plane of the optical system along the optical axis, satisfy: L/TTL≥0.1.

According to an embodiment of the disclosure, the distance TTL from the center of the side surface of the lens group facing away from the cylindrical lens to the imaging plane of the optical system along the optical axis, the maximum field of view FOV of the optical system, and the image height H corresponding to the maximum field of view satisfy the relationship: TTL/H/FOV*180°≤54.

An optical system according to an embodiment in a fourth aspect of the present disclosure, includes: a lens group; and a microstructure array, disposed on a transmission optical path of the lens group, the microstructure array including multiple microstructures arranged in a first direction and a second direction, the first direction and the second direction having an included angle therebetween; where an optical parameter of the microstructure in the first direction satisfies a preset condition, such that a focal length of the optical system in the first direction is smaller than a focal length of the optical system in the second direction, and the optical parameter includes a focal length and/or a radius of curvature.

According to an embodiment of the disclosure, the optical parameters include the focal length, and the preset conditions includes that the focal length Fy1 of the microstructure along the first direction and the focal length Fy2 of the lens group along the first direction satisfy: |Fy1/Fy2|≥1.1.

According to an embodiment of the disclosure, the optical parameters include the focal length, and the preset conditions include the focal length Fy1 of the microstructure along the first direction, the focal length Fy2 of the lens group along the first direction, and the air spacing d between the lens group and the microstructure array, satisfying: 0.10≤Fy2/(Fy1*SQRT(d)).

According to an embodiment of the disclosure, the microstructure array further includes a substrate, with multiple microstructures arranged in an array on a side of the substrate facing the lens group and/or on a side facing away from the lens group.

According to an embodiment of the disclosure, along the direction of the optical axis of the lens group, the microstructure has a convex surface protruding in a direction facing away from the substrate. The optical parameters include the radius of curvature, and the preset conditions include the radius of curvature R of the convex surface along the first direction and the focal length Fy0 of the optical system along the first direction, satisfying: |R/Fy0|≥0.5.

According to an embodiment of the disclosure, the focal length Fy0 of the optical system along the first direction and the focal length Fx0 of the optical system along the second direction satisfy: Fx0/Fy0≥1.01.

According to an embodiment of the disclosure, the maximum aperture D of the microstructure array, the image height H corresponding to the maximum field of view of the optical system, and the distance L between the center of the image-side surface of the microstructure array and the center of the imaging plane of the optical system satisfy: D*L/H≥5.

According to an embodiment of the disclosure, the focal length F of the optical system and the entrance pupil diameter ENPD of the optical system satisfy: F/ENPD≤2.

According to an embodiment of the disclosure, the distance L between the center of the image-side surface of the microstructure array and the center of the imaging plane of the optical system, and the total track length TTL of the optical system satisfy: L/TTL≥0.1.

According to an embodiment of the disclosure, the total track length TTL of the optical system, the maximum field of view FOV of the optical system, and the image height H corresponding to the maximum field of view satisfy: TTL/H/FOV≤0.3.

According to an embodiment of the disclosure, at least two of the multiple microstructures have different thicknesses along the optical axis direction.

According to an embodiment of the disclosure, the difference between the maximum thickness and the minimum thickness of the microstructures is not greater than 0.1 mm.

An optical module according to an embodiment in a fifth aspect of the present disclosure, includes: a photosensitive chip, a size of the photosensitive chip in a first direction being larger than a size of the photosensitive chip in a second direction; and an optical system in the first aspect of the present disclosure, the photosensitive chip being disposed on an image plane of the optical system, and the image plane being disposed on a side of an optical element of the optical system facing away from a lens group.

A LiDAR device according to an embodiment in a sixth aspect of the present disclosure, includes: a radar receiving end. The radar receiving end may include an optical system according to the above embodiments, for receiving reflected light from a detected object.

A method for mounting an optical module according to an embodiment in a seventh aspect of the present disclosure, including: sequentially assembling, in a direction from an object side to an image side of a lens barrel, an optical element and a lens group into the lens barrel to form an optical system; fixing a photosensitive chip to a board surface of a circuit board; and fixing the lens barrel to the circuit board and positioning the lens barrel to cover the photosensitive chip; where the optical element has different focal lengths in a first direction and a second direction, the first direction and the second direction have an included angle therebetween and are both perpendicular to the optical axis, a focal length of the optical system in the first direction is smaller than a focal length of the optical element in the second direction, an optical parameter of the optical element in the first direction satisfies a preset condition, such that the focal length of the optical system in the first direction is smaller than the focal length of the optical system in the second direction, the optical parameter includes a focal length and/or a radius of curvature; and a size of the photosensitive chip in the first direction is larger than a size of the photosensitive chip in the second direction.

It should be understood that the content described in this section is not intended to identify key or critical features of the embodiments of the present disclosure, nor is it used to limit the scope of the present disclosure. Other features of the present disclosure will become readily apparent from the following description.

### BRIEF DESCRIPTION OF THE DRAWINGS

Other features, objectives, and advantages of the present disclosure will become more apparent from the following detailed description of non-limiting embodiments with reference to the accompanying drawings. The accompanying drawings are used for a better understanding of the present solution, and do not constitute a limitation of the present disclosure. In the drawings:

FIG. 1 is a schematic structural diagram of an optical system in some technologies;

FIG. 2 is a picture of a light spot formed by an optical system on an image plane in the existing technology;

FIG. 3 is a schematic structural diagram of an optical system according to some embodiments of the present disclosure;

FIG. 4 is a picture of a light spot formed by an optical system on an image plane according to some embodiments of the present disclosure;

FIG. 5 is a schematic diagram of a free-form surface according to some embodiments of the present disclosure;

FIG. 6 is a schematic structural diagram an optical module according to the present disclosure; and

FIG. 7 is a schematic structural diagram of another optical module according to the present disclosure.

FIG. 8 is a schematic structural diagram of an optical system according to some embodiments of the present disclosure;

FIG. 9 is a schematic structural diagram of an optical system according to some other embodiments of the present disclosure;

FIG. 10 is a schematic structural diagram of a cylindrical lens according to some embodiments of the present disclosure;

FIG. 11 is a schematic diagram of a light spot formed by an optical system according to some embodiments of the present disclosure;

FIG. 12 is a schematic diagram of a light spot formed by an optical system according to some other embodiments of the present disclosure; and

FIG. 13 is a schematic diagram of a light spot formed by an optical system according to some other embodiments of the present disclosure.

FIG. 14 is a schematic structural diagram of an optical system according to some embodiments of the present disclosure;

FIG. 15 is a schematic structural diagram of a microstructure array according to some embodiments of the present disclosure;

FIG. 16 is a schematic structural diagram of an optical module according to some embodiments of the present disclosure;

FIG. 17 is a picture of a light spot formed by an optical system on an image plane according to some embodiments of the present disclosure;

FIG. 18 is a picture of a light spot formed by an optical system on an image plane according to some other embodiments of the present disclosure;

FIG. 19 is a schematic structural diagram of an optical module according to some embodiments of the present disclosure;

FIG. 20 is a picture of a light spot formed by an optical system on an image plane according to some embodiments of the present disclosure;

FIG. 21 is a schematic structural diagram of an optical module according to some embodiments of the present disclosure; and

FIG. 22 is a picture of a light spot formed by an optical system on an image plane according to some embodiments of the present disclosure.

### REFERENCE NUMERALS

100, optical system; 110, lens; 111, photosensitive component; 120, optical element; 121, free-form surface; 200, image plane; 300, photosensitive chip; 800, optical system; 810, lens assembly; 820, cylindrical lens; 830, photosensitive component; 500, microstructure array; 510, microstructure.

### DETAILED DESCRIPTION OF EMBODIMENTS

In the description of the embodiments of the present disclosure, it should be noted that the terms “longitudinal”, “lateral”, “upper”, “lower”, “top”, “bottom”, “inner”, “outer”, and other indications of orientation or state relationships are based on the orientation or state relationships shown in the drawings. These terms are only for the purpose of facilitating the description of the embodiments of the present disclosure and simplifying the description, and are not intended to indicate or imply that the devices or elements referred to must have specific orientations, be constructed or operated in specific orientations. Therefore, they cannot be understood as limitations on the embodiments of the present disclosure. Additionally, the terms “first”, “second”, “third” are used only for descriptive purposes and cannot be understood as indicating or implying relative importance.

In the description of the embodiments of the present disclosure, it should be noted that unless otherwise explicitly defined or limited, the terms “connected” and “connection” should be interpreted broadly. They can refer to fixed connections, detachable connections, or integral connections; mechanical connections or electrical connections; direct connections or indirect connections through intermediary media. Those skilled in the art can understand the specific meaning of above terms in the embodiments of the present disclosure based on the specific context.

In the embodiments of the present disclosure, unless otherwise explicitly defined or limited, the first feature “on” or “under” the second feature may mean that the first and second features are in direct contact, or that they are indirectly in contact through an intermediary medium. Furthermore, the first feature “above”, “over”, or “upper than” the second feature may mean that the first feature is directly above or obliquely above the second feature, or merely that the first feature is at a higher horizontal level than the second feature. The first feature “below”, “under”, or “beneath” the second feature may mean that the first feature is directly below or obliquely below the second feature, or merely that the first feature is at a lower horizontal level than the second feature.

In the embodiments of the present disclosure, unless otherwise explicitly defined or limited, the terms “lens assembly”, “lens group”, and “plurality of lenses” all refer to a lens group that is composed of multiple lenses.

The following provides an explanation of exemplary embodiments of the present application in conjunction with the accompanying drawings, which include various details of the embodiments to facilitate understanding. These details should be considered as merely exemplary. Therefore, those of ordinary skill in the art should recognize that various changes and modifications can be made to the embodiments described herein without departing from the scope and spirit of the present application. Similarly, for clarity and conciseness, descriptions of well-known functions and structures have been omitted from the following description.

It should be noted that, in case of no conflict, the embodiments and features of the embodiments in the present disclosure can be combined with each other. Hereinafter, the present disclosure will be described in detail with reference to the accompanying drawings and in conjunction with embodiments.

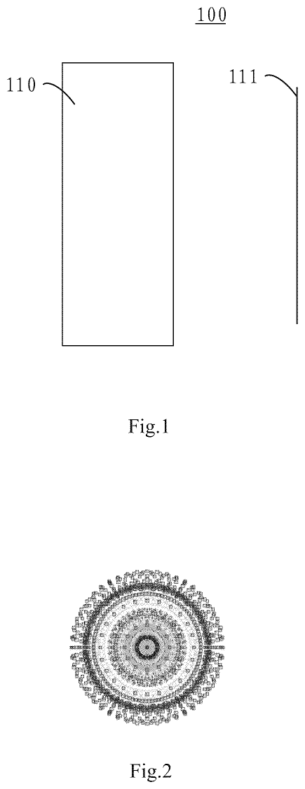

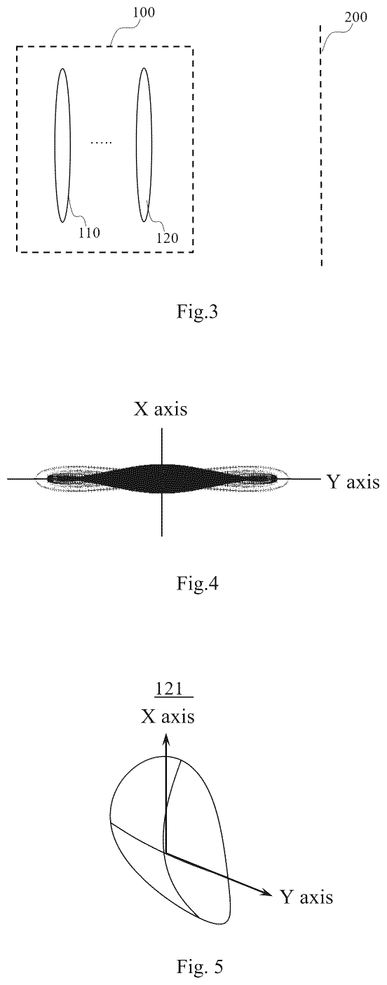

FIG. 1 is a schematic structural diagram of an optical system in some technologies. FIG. 1 is a schematic diagram of a light spot formed by the optical system exemplified in FIG. 2. As shown in FIG. 1, an optical system 100 includes a lens assembly 110 and a photosensitive component 111. Due to the lens assembly 110 in the optical system 100 being a combination of lenses that are rotationally symmetric along the optical axis, the focal length along the X-axis of the lens assembly 110 is the same as that along the Y-axis. This results in the light spot received by the photosensitive component 111, as shown in FIG. 2, being approximately circular, which leads to a waste of space on the photosensitive component 111 and low space utilization efficiency.

In related technologies, an optical lens assembly is composed of multiple spherical or aspherical lenses spaced along the optical axis, and the lenses are typically circular. As shown in FIG. 2, external light passes through the circular lenses sequentially to form a circular light spot that irradiates the photosensitive chip.

To address at least the aforementioned issues, embodiments of the present disclosure provide an optical system 100 including multiple lenses 110 arranged sequentially from the object side to the image side along the optical axis. Among these lenses, at least one lens is a free-form surface lens 120. The optical parameters of the free-form surface lens 120 along a first direction satisfy predefined conditions, such that the focal length of the optical system 100 along the first direction is smaller than the focal length of the optical system 100 along a second direction. The first direction and the second direction have an angle between them and are both perpendicular to the optical axis.

As can be seen from the above, by configuring at least one lens in the lens group 110 as a free-form surface lens 120 and satisfying predefined conditions for the optical parameters of the free-form surface lens 120 along a first direction in the embodiments of the present disclosure, the focal length of the entire optical system 100 along the first direction can be reduced, making it smaller than the focal length along a second direction. Consequently, external light passes through each lens 110 sequentially, first converging and then diverging, resulting in a light spot on the imaging plane 200 that is elongated along the first direction. In other words, the light spot formed on the imaging plane 200 is elongated in a strip shape along the first direction. Thus, when the optical system 100 of the embodiments of the present disclosure is applied to an optical module, it not only improves the utilization rate of the photosensitive area of the photosensitive chip 300 but also avoids the need to add additional optical components. This reduces costs while having no impact on the back focal length of the optical system 100 or the energy of the formed light spot.

It should be noted that the optical system 100 in the embodiments of the present disclosure may be, but is not limited to, a receiving end of a lidar. Additionally, the first direction and the second direction may be perpendicular to each other or not. For example, as shown in FIGS. 4 and 5, the first direction is the y-axis direction, and the second direction is the x-axis direction. Optionally, there may be an acute or obtuse angle between the first direction and the second direction. Furthermore, the lenses 110 may be glass lenses or plastic lenses. If the operating ambient environment has a high temperature and there are high requirements for image resolution quality, glass lenses may be selected.

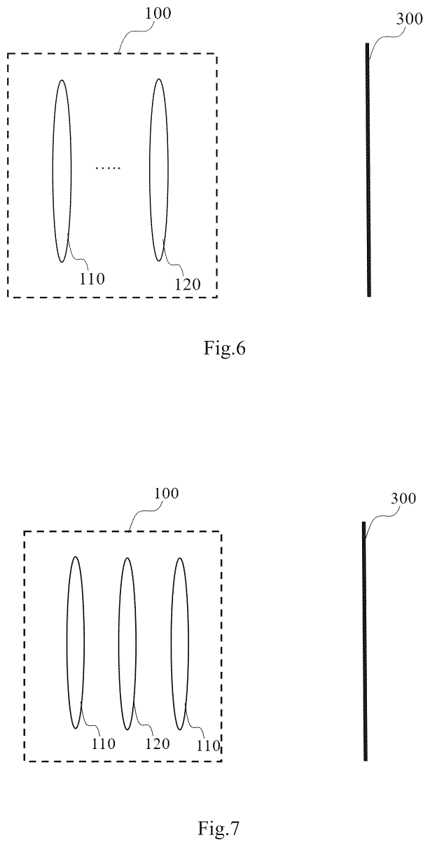

In some embodiments, as shown in FIG. 6, the free-form surface lens 120 is a lens close to the image side, and an image-side surface of the free-form surface lens 120 is a free-form surface, in other words, along the object side to the image side, the last lens in the optical system 100 is the free-form surface lens 120, and a side of the free-form surface lens 120 facing the image plane is a free-form surface. It should be noted that the number of free-form surface lenses 120 in the optical system 100 may be one or more. In addition, the free-form surface lens 120 may be the lens closest to the image side or any other lens. In other words, any one of the lenses 110 may be the free-form surface lens 120, as long as the focal length of the optical system 100 along the first direction is made less than the focal length of the optical system 100 along the second direction. For example, as shown in FIG. 7, the optical system 100 includes three lenses 110, and a lens in the middle of the three lenses 110 is the free-form surface lens 120.

In some embodiments, the focal length Fy0 of the optical system 100 in the first direction and the focal length Fx0 of the optical system 100 in the second direction satisfy: Fx0/Fy0≥1.005. Further, Fx0/Fy0≥1.007. For example, the value of Fx0/Fy0 may be 1.006, 1.007, 1.008 or 1.009.

In the disclosure, the focal length and/or radius of curvature of the free-form lens 120 may be restricted to achieve a focal length of the optical system 100 along a first direction that is smaller than the focal length of the optical system 100 along a second direction. The preset conditions that the focal length or radius of curvature of the free-form lens 120 should satisfy may include, but are not limited to, at least one of the following.

First, a radius of curvature Ry of a free-form surface 121 in the first direction and a radius of curvature Rx of the free-form surface 121 in the second direction satisfy: |Ry/Rx|≥1.02. Further, 1.05≤|Ry/Rx|≤1.5. For example, the value of |Ry/Rx| may be 1.1, 1.2, 1.3, or 1.4. By using the above conditional expression to control the radii of curvature of the free-form surface 121 of the free-form surface lens 120 in the first and second directions in the embodiments of the present disclosure, the focal length of the free-form surface lens 120 in the first direction can be reduced, thereby making the focal length of the optical system 100 in the first direction smaller than that in the second direction. As a result, external light passing through the optical system 100 converges first and then diverges, so that not only a strip-shaped light spot extending in the first direction can be formed on the imaging plane 200 eventually, but also the light spot distribution is more uniform, making the energy received by the photosensitive chip 300 higher.

Second, the radius of curvature Ry of the free-form surface 121 in the first direction and the focal length Fy0 of the optical system 100 in the first direction satisfy: Ry/Fy0≥1. Further, Ry/Fy0≥1.35. For example, the value of Ry/Fy0 may be 1.6, 1.9, 2.1, or 2.4. By using the above conditional expression to control the radius of curvature of the free-form surface 121 of the free-form surface lens 120 in the first direction and the focal length of the optical system 100 in the first direction in the embodiments of the disclosure, the focal length of the free-form surface lens 120 in the first direction can be reduced, thereby making the focal length of the optical system 100 in the first direction smaller than that in the second direction. As a result, external light passing through the optical system 100 converges first and then diverges, so that not only a strip-shaped light spot extending in the first direction can be formed on the imaging plane 200 eventually, but also the light spot distribution is more uniform, making the energy received by the photosensitive chip 300 higher.

Third, the focal length Fy1 of the free-form surface lens 120 in the first direction and the focal length Fy0 of the optical system 100 in the first direction satisfy: |Fy1/Fy0|≥0.5. Further, 0.7≤| Fy1/Fy0|≤1. For example, the value of |Fy1/Fy0| may be 0.6, 0.8, 0.7, or 0.9. By using the above conditional expression to control the focal lengths of the free-form surface lens 120 and the optical system 100 in the first direction in the embodiments of the disclosure, the focal length of the free-form surface lens 120 in the first direction can be reduced, thereby making the focal length of the optical system 100 in the first direction smaller than that in the second direction. As a result, external light passing through the optical system 100 converges first and then diverges, eventually forming a strip-shaped light spot extending in the first direction on the imaging plane 200.

Fourth, the focal length Fy1 of the free-form surface lens 120 in the first direction and the focal length Fx1 of the free-form surface lens 120 in the second direction satisfy: 1.003≤Fx1/Fy1. Further, 1.003≤Fx1/Fy1≤1.055. As an example, 1.004≤Fx1/Fy1≤1.018. For example, the value of Fx1/Fy1 may be 1.0035, 1.004, 1.0045, 1.005, 1.006, 1.007, 1.008, or 1.009. By using the above conditional expression to control the focal lengths of the free-form surface lens 120 in the first and second directions in the embodiments of the disclosure, the focal length of the free-form surface lens 120 in the first direction may be made smaller than that in the second direction. As a result, external light passing through the optical system 100 converges first and then diverges, so that not only a strip-shaped light spot extending in the first direction can be formed on the imaging plane 200 eventually, but also the light spot distribution is more uniform, making the energy received by the photosensitive chip 300 higher.

In some embodiments, a maximum effective aperture D of the optical system 100, a distance L between a center of the free-form surface 121 and a center of the image plane 200 of the optical system 100, and an image height H corresponding to a maximal field-of-view of the optical system 100 satisfy: D*L/H≥5. Further, D*L/H≥10. As an example, 20≤D*L/H≤35. For example, the value of D*L/H may be 22, 25, 27, 30, or 32. By controlling, with the above conditional expressions, the maximum effective aperture of the optical system 100, the distance between the center of the free-form surface 121 and the center of the image plane 200 of the optical system 100, and the image height corresponding to the maximal field-of-view of the optical system 100, an embodiment of the present disclosure may not only control a size of the free-form surface lens 120 within a reasonable range, but also increase the back focal length of the optical system 100, so as to reduce an included angle between lights reaching the image plane 200 and the optical axis, thus realizing a small CRA (Chief Ray Angle).

In some embodiments, a focal length F of the optical system 100 and an entrance pupil diameter ENPD of the optical system 100 satisfy: F/ENPD≤1.8. Further, 1.1≤F/ENPD≤1.6. For example, the value of F/ENPD may be 1.2, 1.3, 1.4, or 1.5. By controlling, with the above conditional expressions, the focal length and the entrance pupil diameter of the optical system 100, an embodiment of the present disclosure may realize a small FNO, i.e., F/ENPD, increasing admitted light of the optical system 100, so that a strip-shaped light spot formed on the image plane 200 is brighter.

In some embodiments, the distance L between the center of the free-form surface 121 and the center of the image plane 200 of the optical system 100 and a total track length TTL of the optical system 100 satisfy: L/TTL≥0.1. Further, L/TTL≥0.12. For example, the value of L/TTL may be 0.14, 0.16, 0.18, or 0.2. By controlling, with the above conditional expressions, the distance L between the center of the free-form surface 121 of the free-form surface lens 120 and the center of the image plane 200 of the optical system 100 and the total track length TTL of the optical system 100, an embodiment of the present disclosure may increase the back focal length of the optical system 100, which not only reserves space for the mounting and focusing of optical components such as the lens 110, thereby facilitating the assembly of the optical system 100, but also avoids interference between optical components.

In some embodiments, the total track length TTL of the optical system 100, the maximal field-of-view FOV of the optical system 100, and the image height H corresponding to the maximal field-of-view of the optical system 100 satisfy: TTL/H/FOV≤0.3. Further, TTL/H/FOV≤0.15. For example, the value of TTL/H/FOV may be 0.12, 0.1, 0.05, 0.03, or 0.02. By controlling, with the above conditional expressions, the total track length of the optical system 100, the maximal field-of-view of the optical system 100, and the image height corresponding to the maximal field-of-view of the optical system 100, in the embodiments of the present, with the ratio between the maximum field of view of the optical system 100 and the corresponding image height remaining unchanged, the total optical length of the optical system 100 can be reduced, thereby achieving the miniaturization of the optical system 100.

In some embodiments, the total track length TTL of the optical system 100, a sag SAGy of the free-form surface 121 in the first direction and a sag SAGx of the free-form surface 121 in the second direction satisfy: TTL/[(SAGx+SAGy)/2]≥40. Further, 50≤TTL/[(SAGx+SAGy)/2]≤70. For example, the value of TTL/[(SAGx+SAGy)/2] may be 55, 60, 65, or 70. By controlling, with the above conditional expressions, the total track length of the optical system 100, the sags of the free-form surface 121 of the free-form surface lens 120 in the first direction and the second direction, an embodiment of the present disclosure may control the sags of the free-form surface 121 in the first direction and the second direction within a reasonable range, ensuring a smooth transition of the surface shape of the free-form surface 121 from the center to the edges. Consequently, it not only reduces reflections between the free-form surface 121 and the imaging plane 200 but also decreases ghost image energy.

In some embodiments, the distance L between the center of the free-form surface 121 and the center of the image plane 200 of the optical system 100 and the focal length Fx0 of the optical system 100 in the second direction satisfy: 0.2≤L/Fx0≤1. Further, 0.4≤L/Fx0≤0.7. For example, the value of L/Fx0 may be 0.45, 0.5, 0.55, 0.6 or 0.65. By controlling, with the above conditional expressions, the distance L between the center of the free-form surface 121 and the center of the image plane 200 of the optical system 100, and the focal length Fx0 of the optical system 100 in the second direction, an embodiment of the present disclosure may increase the back focal length of the optical system 100, which not only reserves space for the mounting and focusing of optical elements such as the lenses 110, thus facilitating assembly of the optical system 100, but also avoiding interference between the optical elements.

Further, as shown in FIG. 6 and FIG. 7, an embodiment of the present disclosure also provides an optical module, the optical module includes the photosensitive chip 300 and the optical system 100 described above, the photosensitive chip 300 is disposed on the image plane 200 of the optical system 100, and a size of the photosensitive chip 300 in the first direction is greater than a size of the photosensitive chip 300 in the second direction.

In the embodiment of the present disclosure, at least one lens in the optical system 100 is a free-form lens 120, and the optical parameters of the free-form lens 120 along the first direction meet preset conditions, resulting in the focal length of the optical system 100 along the first direction being smaller than its focal length along the second direction. Consequently, after passing through the optical system 100, the light rays first converge and then diverge, forming a spot on the imaging plane 200 that is elongated along the first direction. In other words, the spot formed on the imaging plane 200 is elongated in shape along the first direction. The photosensitive chip 300 has dimensions that are larger along the first direction than along the second direction, meaning that the shape of the spot is compatible with the shape of the photosensitive chip 300. Therefore, almost the entire photosensitive area of the photosensitive chip 300 is irradiated by the spot, both along the first direction and the second direction. This not only improves the utilization rate of the photosensitive area of the photosensitive chip 300 but also eliminates the need for additional optical elements, thereby reducing costs without compromising the back focal length of the optical system 100 or the energy of the formed spot.

Examples of the optical module in different structural forms in the embodiments of the present disclosure are described below.

### Embodiment 1

An optical module in the present embodiment includes an optical system 100 and a photosensitive chip 300, the optical system 100 includes multiple lenses 110 disposed sequentially along an optical axis from an object side to an image side, a lens 110 in a lens group 110 close to the image side is a free-form surface lens 120, an image-side surface of the free-form surface lens 120 is a free-form surface 121, and an optical parameter of the free-form surface lens 120 in a first direction satisfies a preset condition, such that a focal length of the optical system 100 in the first direction is smaller than a focal length of the optical system 100 in a second direction, and the first direction and the second direction have an included angle between them and are both perpendicular to the optical axis.

Table 1 below illustrates a radius of curvature Ry of the free-form surface 121 of the free-form surface lens 120 in the first direction, a radius of curvature Rx of the free-form surface 121 in the second direction, a focal length Fy1 of the free-form surface lens 120 in the first direction, a focal length Fx1 of the free-form surface lens 120 in the second direction, a focal length Fy0 of the optical system 100 in the first direction, a focal length Fx0 of the optical system 100 in the second direction, a maximum effective aperture D of the optical system 100, a distance L between a center of the free-form surface and a center of an image plane 200 of the optical system 100, an image height H corresponding to a maximal field-of-view of the optical system 100, a focal length F of the optical system 100, an entrance pupil diameter ENPD of the optical system 100, a total track length TTL of the optical system 100, the maximal field-of-view FOV of the optical system 100, a sag SAGy of the free-form surface 121 in the first direction, and a length Ly of a strip-shaped light spot in the first direction in Embodiment 1.

TABLE 1

| parameter | Ry (mm) | Rx (mm) | Fy1 (mm) | Fx1 mm) | Fy0 (mm) | Fx0 (mm) |
|---|---|---|---|---|---|---|
| value | 62.61 | 59.38 | 27.59 | 27.95 | 33.82 | 34.17 |

| parameter | D(mm) | L (mm) | H (mm) | F (mm) | ENPD (mm) | TTL (mm) |
|---|---|---|---|---|---|---|
| value | 20.92 | 18.63 | 16.05 | 34.17 | 24.3 | 49.98 |

| parameter | FOV(°) | SAGy(mm) | SAGx(mm) | Ly (um) |
|---|---|---|---|---|
| value | 26.5 | 0.837 | 0.915 | 200 |

### Embodiment 2

The structure of the optical module in this embodiment is basically the same as that of the optical module in Embodiment 1. For parts that are identical to Embodiment 1, this embodiment will not repeat the details. The difference lies in: a radius of curvature of the free-form surface 121 in the first direction Ry=71.15 mm, a focal length of the free-form surface lens 120 in the first direction Fy1=26.84 mm, and a focal length of the optical system 100 in the first direction Fy0=33.07 mm.

Table 2 below illustrates the radius of curvature Ry of the free-form surface 121 of the free-form surface lens 120 in the first direction, a radius of curvature Rx of the free-form surface 121 in the second direction, the focal length Fy1 of the free-form surface lens 120 in the first direction, a focal length Fx1 of the free-form surface lens 120 in the second direction, the focal length Fy0 of the optical system 100 in the first direction, a focal length Fx0 of the optical system 100 in the second direction, a maximum effective aperture D of the optical system 100, a distance L between a center of the free-form surface and a center of an image plane 200 of the optical system 100, an image height H corresponding to a maximal field-of-view of the optical system 100, a focal length F of the optical system 100, an entrance pupil diameter ENPD of the optical system 100, a total track length TTL of the optical system 100, the maximal field-of-view FOV of the optical system 100, a sag SAGy of the free-form surface 121 in the first direction, and a length Ly of a strip-shaped light spot in the first direction in Embodiment 2.

TABLE 2

| parameter | Ry (mm) | Rx (mm) | Fy1 (mm) | Fx1 mm) | Fy0 (mm) | Fx0 (mm) |
|---|---|---|---|---|---|---|
| value | 71.15 | 59.38 | 26.84 | 27.95 | 33.07 | 34.17 |

| parameter | D(mm) | L (mm) | H (mm) | F (mm) | ENPD (mm) | TTL (mm) |
|---|---|---|---|---|---|---|
| value | 20.92 | 18.63 | 16.05 | 34.17 | 24.3 | 49.98 |

| parameter | FOV(°) | SAGy(mm) | SAGx(mm) | Ly (um) |
|---|---|---|---|---|
| value | 26.5 | 0.725 | 0.915 | 600 |

In summary, Embodiment 1 and Embodiment 2 satisfy the relationships shown in Table 3 below.

TABLE 3

| | |
|---|---|
| conditional | embodiment |

| expression | Embodiment 1 | Embodiment 2 |
|---|---|---|
| \|Ry/Rx\| | 1.055 | 1.198 |
| Ry/Fy0 | 1.851 | 2.151 |
| \|Fy1/Fy0\| | 0.82 | 0.81 |
| Fx1/Fy1 | 1.013 | 1.041 |
| Fx0/Fy0 | 1.01 | 1.034 |
| D*L/H | 24.29 | 24.29 |
| F/ENPD | 1.41 | 1.41 |
| L/TTL | 0.37 | 0.37 |
| TTL/H/FOV | 0.12 | 0.12 |
| TTL/[(SAGx + SAGy)/2] | 57.026 | 60.926 |
| L/Fx0 | 0.55 | 0.55 |

According to Table 3, |Ry/Rx|≥1.02, Ry/Fy0≥1, |Fy1/Fy0|≥0.5, and 1.003≤Fx1/Fy1 in Embodiment 1 and Embodiment 2. By utilizing the aforementioned four conditional expressions, in the present disclosure, the relative magnitudes of the radii of curvature of the free-form surface 121 of the free-form lens 120 along the first and second directions, the relative magnitudes of the radius of curvature of the free-form surface 121 along the first direction and the focal length of the optical system 100 along the first direction, the relative magnitudes of the focal lengths of the free-form lens 120 and the optical system 100 along the first direction, and the relative magnitudes of the focal lengths of the free-form lens 120 along the first and second directions are respectively controlled. This allows for a reduction in the focal length of the free-form lens 120 along the first direction, resulting in the focal length of the optical system 100 along the first direction being smaller than its focal length along the second direction. Consequently, external light rays passing through the optical system 100 first converge and then diverge, ultimately forming a long strip-shaped light spot on the imaging plane 200 that extends along the first direction.

In addition, according to Table 3, it can also be seen that D*L/H≥5, F/ENPD≤1.8, L/TTL≥0.1, TTL/H/FOV≤0.3, TTL/[(SAGx+SAGy)/2]≥40, and 0.2≤L/Fx0≤1. It can be seen that in the disclosure, the size of the free-form lens 120 is controlled within a reasonable range. When D*L/H≥5, the optical system 100 possesses a relatively large back focal length, which reduces the angle between the light rays reaching the imaging plane 200 and the optical axis, achieving a small CPA. Additionally, when F/ENPD≤1.8, a small FNO (F-number) can be achieved, increasing the light throughput of the optical system 100 and making the long strip-shaped light spot formed on the imaging plane 200 brighter. In cases where L/TTL≥0.1, the back focal length of the optical system 100 may also be increased, providing space for the mounting and focusing of optical elements such as the lens 110. When TTL/H/FOV≤0.3, the optical total length of the optical system 100 may be reduced while keeping the ratio of the maximum field of view and the corresponding image height unchanged, thereby achieving miniaturization of the optical system 100. In case where TTL/[(SAGx+SAGy)/2]≥40, it ensures a smooth transition of the surface shape of the free-form surface 121 from the center to the edge, which not only reduces reflections between the free-form surface 121 and the imaging plane 200 but also lowers ghost image energy. When 0.2≤L/Fx0≤1, the back focal length of the optical system 100 may be increased, which not only provides space for the mounting and focusing of optical elements such as the lens 110, facilitating the assembly of the optical system 100, but also avoids interference between optical elements.

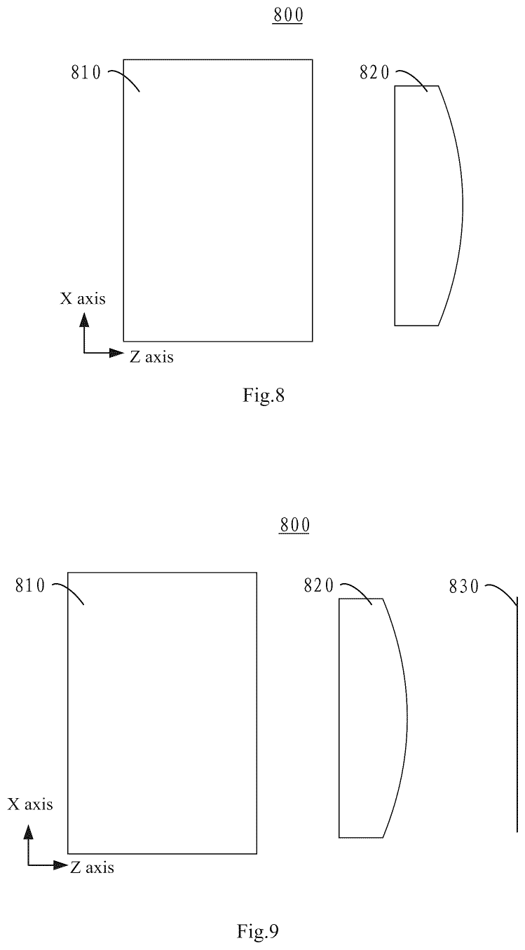

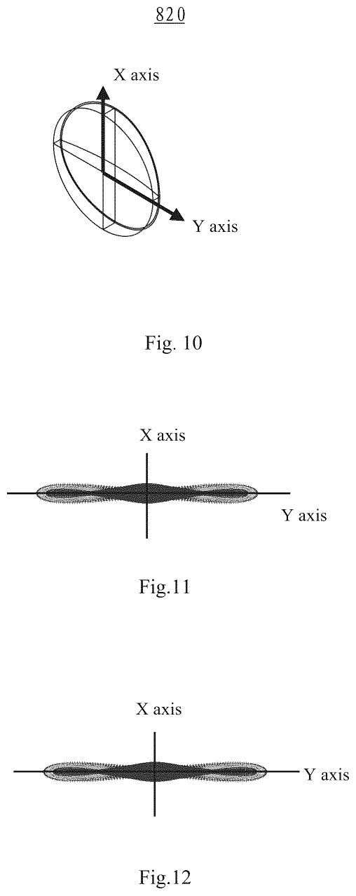

FIG. 8 and FIG. 9 are schematic structural diagrams of an optical system according to some embodiments of the present disclosure; FIG. 10 is a schematic structural diagram of a cylindrical lens according to some embodiments of the present disclosure; and FIG. 11 is a schematic diagram of a light spot formed by an optical system according to some embodiments of the present disclosure.

In some embodiments of the present disclosure, as shown in FIG. 8, an optical system 800 sequentially includes, from a light incidence side to a light exit side: a lens assembly 810 and a cylindrical lens 820. At least one of the surfaces of the cylindrical lens 820, either facing towards the lens assembly 810 or facing away from it, is cylindrical, causing the light passing through the cylindrical lens 820 to have different focal lengths in the X-axis direction and the Y-axis direction. Here, the X-axis direction includes a direction perpendicular to the optical axis of the lens assembly 810, and the Y-axis direction includes a direction perpendicular to both the optical axis and the X-axis direction.

According to some embodiments of the present disclosure, by arranging a cylindrical lens on the light exit side of the lens assembly to adjust the X-axis focal length and Y-axis focal length of the optical system 800, the shape of the light spot can be altered, thereby enhancing the space utilization of backend components (such as photosensitive components). Additionally, utilizing the cylindrical lens 820 to adjust the shape of the light spot involves low processing difficulty, low cost, and is easy to implement in mass production.

As shown in FIG. 9, the optical system 800 further includes: a photosensitive component 830, disposed on the side of the cylindrical lens 820 that is farther away from the lens assembly 810. Optionally, the photosensitive component 830 may include an image sensor chip. The image sensor chip can decompose the image captured by the lens assembly 810 into at least millions of pixels for transmission to the backend.

It should be understood that, for ease of understanding, FIG. 8 and FIG. 9 provide exemplary illustrations with the surface of the cylindrical lens 820 facing away from the lens assembly 810 being cylindrical. In other embodiments, the surface of the cylindrical lens 820 closer to the lens assembly 810 may also be cylindrical, and the present disclosure does not limit this.

In some embodiments of the present disclosure, the lens assembly 810 may include a lens group. The lens group can converge light emitted from external scenes and transmit it to the photosensitive component 830.

It should be understood that without departing from the teachings of the present disclosure, the type and number of lenses in the lens group may be set as needed, which is not limited in the present disclosure.

In some embodiments, the cylindrical lens 820 may be implemented as a concave cylindrical lens, which is employed to adjust the X-axis and Y-axis focal lengths of the optical system 800. By doing so, it is possible to increase the focal length in a single direction, thereby controlling the length of the light spot.

In some embodiments of the present disclosure, the cylindrical lens 820 may be a convex cylindrical lens, which first converges and then diverges the light beam, stretching and elongating the light spot, thereby achieving a more uniform distribution of the light spot and a higher encircled energy. Compared to a concave cylindrical lens, under the condition of the same spot length, the optical system 800 utilizing a convex cylindrical lens produces a light spot with higher energy than the optical system 800 using a concave cylindrical lens.

As an option, as shown in FIG. 10, the cylindrical lens 820 may be a convex cylindrical lens with a convex surface in the Y-axis direction. Optionally, the Y-axis direction is parallel to a direction of extension of a long side of a photosensitive area of the photosensitive component, and the X-axis direction is perpendicular to the Y-axis direction. For example, the Y-axis direction and the X-axis direction may be referenced as shown in FIG. 10. The light spot formed by the optical system 800 using this cylindrical lens 820 is as shown in FIG. 11. Due to the convex surface formed by the convex cylindrical lens in the Y-axis direction, the focal length of the convex cylindrical lens in the Y-axis direction is reduced, causing the focal point on the Y-axis to be in front of the imaging plane. The light beam converges first and then diverges, stretching and elongating the light spot, which in turn results in a more uniform light spot distribution and higher encircled energy.

It should be understood that without departing from the teachings of the present disclosure, the convex cylindrical lens may Optionally form a convex surface in another direction, which is not limited in the present disclosure.

As an option, the convex cylindrical lens may include a plano-convex cylindrical lens or a biconvex cylindrical lens. By using the plano-convex cylindrical lens or the biconvex cylindrical lens, the focal length of the optical system 800 may be adjusted to change the shape of the light spot, thereby improving the space utilization rate of the photosensitive component 830.

It should be understood that other types of convex cylindrical lenses may also be used in other embodiments without departing from the teachings of the present disclosure, which is not limited in the present disclosure.

As an option, referring to FIG. 9, the convex cylindrical lens is a plano-convex cylindrical lens, and the convex surface of the plano-convex cylindrical lens faces away from the lens assembly 810. As an example, the radius of curvature R of the side surface of the convex cylindrical lens facing away from the lens assembly in the Y-axis direction and the Y-axis focal length Fy0 of the optical system satisfy: R/Fy0≤−5. Optionally, the radius of curvature R of the side surface of the convex cylindrical lens facing away from the lens assembly in the Y-axis direction and the Y-axis focal length Fy0 of the optical system satisfy the range: −45≤R/Fy0≤−8. By controlling the radius of curvature of the cylindrical lens 820, the Y-axis focal length of the entire system is reduced, causing the light beam exiting from the cylindrical lens 820 to first converge and then diverge. This results in the stretching and elongating of the light spot, facilitating the formation of an elongated light spot with a more uniform distribution and higher encircled energy.

It should be understood that without departing from the teachings of the present disclosure, in other embodiments, the arrangement of the convex cylindrical lens may be adjusted as needed, which is not limited in the present disclosure.

Optionally, in some embodiments, the radius of curvature R of the convex surface of the convex cylindrical lens in the Y-axis direction and the Y-axis focal length Fy0 of the optical system satisfy: |R/Fy0|≥5. Optionally, the radius of curvature R of the convex surface of the convex cylindrical lens in the Y-axis direction and the Y-axis focal length Fy0 of the optical system satisfy: 8≤|R/Fy0|␣45.

For example, the convex cylindrical lens is a plano-convex cylindrical lens, as described above, the radius of curvature R of the side surface of the convex cylindrical lens farther away from the lens assembly in the Y-axis direction and the Y-axis focal length Fy0 of the optical system satisfy: R/Fy0≤−5.

As another example, the convex cylindrical lens is a biconvex cylindrical lens, the radius of curvature R of the convex surface farther away from the lens assembly in the Y-axis direction and the Y-axis focal length Fy0 of the optical system satisfy: R/Fy0≤−5, and the radius of curvature R of the convex surface closer to the lens assembly in the Y-axis direction and the Y-axis focal length Fy0 of the optical system satisfy: R/Fy0≥5.

In this example, the use of the biconvex cylindrical lens may improve a focal length adjustable range of the cylindrical lens 820, achieve a better adjustment effect on the light spot, and better improve the utilization rate of the photosensitive component 830.

In some embodiments of the present disclosure, a Y-axis focal length Fy1 of the cylindrical lens 820, a Y-axis focal length Fy2 of the lens assembly 810, and a distance d from the center of the side surface of the cylindrical lens 820 closer to the lens assembly 810 to a center of a side surface of a last lens in the lens assembly 810 closer to the cylindrical lens 820 on the optical axis of the optical system 800 satisfy: Fy2/(Fy1*\sqrt{d})≥0.005. Optionally, Fy1, Fy2, and d satisfy: 0.005≤Fy2/(Fy1*\sqrt{d})≤0.05. Optionally, Fy1, Fy2, and d satisfy: 0.006≤Fy2/(Fy1*\sqrt{d})≤0.028. By altering the radius of curvature of the cylindrical lens 820 along the Y-axis, the focal length along the Y-axis is changed, resulting in different focal lengths along the X-axis and Y-axis of the optical system 800. Additionally, by adjusting the distance between the cylindrical lens 820 and the lens assembly 810, the length of the light spot along the Y-axis is jointly controlled, thereby managing the shape of the light spot on the imaging plane.

In some embodiments of the present disclosure, the Y-axis focal length Fy1 of the cylindrical lens 820 and the Y-axis focal length Fy2 of the lens assembly 810 satisfy: |Fy1/Fy2|≥10. Optionally, Fy1 and Fy2 satisfy: 15≤|Fy1/Fy2|≤90. In this example, By modifying the radius of curvature of the cylindrical lens 820 along the Y-axis, the focal length along the Y-axis is adjusted, causing the optical system 800 to have different focal lengths along the X-axis and Y-axis. This results in the formation of a strip-shaped light spot, which is advantageous for creating a light spot that is compatible with the photosensitive component 830.

In some embodiments of the present disclosure, the X-axis focal length Fx0 and the Y-axis focal length Fy0 of the optical system 800 satisfy: Fx0/Fy0≥1.002. Optionally, Fx0 and Fy0 satisfy: Fx0/Fy0≥1.004. This embodiment allows for the reduction of the focal length of the entire optical system 800 along the Y-axis by controlling the radius of curvature of the cylindrical lens 820, thereby forming a strip-shaped light spot. The cylindrical lens is convex, and in the optical path from the cylindrical lens to the photosensitive component, the light beam first converges and then diverges, stretching and elongating the light spot, which can result in a more uniform distribution of the light spot and higher encircled energy.

In some embodiments of the present disclosure, a maximum effective aperture D of the optical system 800, an image height H corresponding to a maximal field-of-view of the optical system 800, and a distance L from the center of the side surface of the cylindrical lens 820 farther away from the lens assembly 810 to a center of the image plane of the optical system 800 on the optical axis of the optical system 800 satisfy: D*L/H≥5 mm. Optionally, D, H and L satisfy: 8 mm≤D*L/H≤20 mm. By controlling a size of the diameter of the cylindrical lens 820 and the back focal length, an included angle between light reaching the image plane and the optical axis is reduced, and a small CRA is realized.

In some embodiments of the present disclosure, the X-axis focal length Fx0 and an entrance pupil diameter ENPD of the optical system 800 satisfy: Fx0/ENPD≤2. Optionally, F and ENPD satisfy: 1.1≤Fx0/ENPD≤1.6. By controlling the ratio of the focal length Fx0 to the entrance pupil diameter ENPD, a small FNO can be achieved, which is beneficial for increasing the amount of incoming light, making the light spot on the imaging plane brighter.

In some embodiments of the present disclosure, the distance L from the center of the side surface of the cylindrical lens 820 farther away from the lens assembly 810 to the center of the image plane of the optical system 800 on the optical axis of the optical system 800, and a distance TTL from a center of a side surface of the lens assembly 810 farther away from the cylindrical lens 820 to the image plane of the optical system 800 on the optical axis satisfy: L/TTL≥0.1. Optionally, L and TTL satisfy: L/TTL≥0.12. This embodiment allows for a long back focal length of the optical system 800, providing space for the mounting and focusing of optical components, avoiding interference between components, and facilitating the assembly of the optical system 800.

In some embodiments of the present disclosure, the distance TTL from the center of the side surface of the lens assembly 810 farther away from the cylindrical lens 820 to the image plane of the optical system 800 on the optical axis, the maximal field-of-view FOV of the optical system 800 and the image height H corresponding to the maximal field-of-view satisfy: TTL/H/FOV*180°≤54. Optionally, TTL, H, and FOV satisfy: TTL/H/FOV*180°≤27. With the same ratio of the image height to the field-of-view, this embodiment may effectively limit the length of the optical system 800, which is conducive to realizing miniaturization of the optical system 800.

It should be understood that without departing from the teachings of the present disclosure, the optical system 800 may also include other optical components, which is not limited in the present disclosure.

For ease of understanding, some structural parameters of the optical system 800 are exemplarily described below.

### Embodiment 3

In some embodiments of the present disclosure, the optical system 800 may be as shown in FIG. 9. Here, the Y-axis focal length of the cylindrical lens 820 may be 1120.34 mm, an effective diameter of the cylindrical lens 820 may be 21 mm, and a center thickness of the cylindrical lens 820 may be 1.5 mm.

Optionally, the Y-axis focal length Fy1 of the cylindrical lens 820 may be 1120.34 mm, and the Y-axis focal length Fy2 of the lens assembly 810 may be 34.22 mm, such that |Fy1/Fy2|=32.74, which is conducive to forming a light spot that matches the photosensitive component 830.

Optionally, the distance d from the center of the side surface of the cylindrical lens 820 closer to the lens assembly 810 to the center of the side surface of the last lens in the lens assembly 810 closer to the cylindrical lens 820 on the optical axis of the optical system 800 may be 2 mm, such that Fy2/(Fy1*\sqrt{d})=0.022, allowing the length of the light spot in the Y-axis direction to be controlled, thereby controlling the shape of the light spot on the image plane.

Optionally, the X-axis focal length Fx0 of the optical system 800 may be 34.22 mm, and the Y-axis focal length Fy0 of the optical system 800 may be 33.76 mm, Fx0/Fy0=1.014, such that the Y-axis focal length of the entire optical system 800 may be reduced, thereby forming a strip-shaped light spot. The cylindrical lens 820 is a convex surface, and in an optical path from the cylindrical lens 820 to the photosensitive component 830, the light beam first converges and then diverges, so that the light spot is stretched and lengthened, which may lead to a more uniform distribution of the light spot and a higher encircled energy.

Optionally, the maximum effective aperture D of the optical system 800 may be 21 mm, the image height H corresponding to the maximal field-of-view of the optical system 800 may be 16.05 mm, and the distance L from the center of the side surface of the cylindrical lens 820 farther away from the lens assembly 810 to the center of the image plane of the optical system 800 on the optical axis of the optical system 800 may be 15.08 mm, such that D*L/H=19.74. By controlling the size of the diameter of the cylindrical lens 820 and the back focal length, the included angle between light reaching the image plane and the optical axis is reduced, and a small CRA is realized.

Optionally, the X-axis focal length Fx0 of the optical system 800 may be 34.22 mm, and the entrance pupil diameter ENPD of the optical system 800 may be 24.3 mm, such that Fx0/ENPD=1.41, which is conducive for increasing the amount of incoming light, making the light spot on the imaging plane brighter.

Optionally, L may be 15.08 mm, and the distance TTL from the center of the side surface of the lens assembly 810 farther away from the cylindrical lens 820 to the image plane of the optical system 800 on the optical axis may be 49.93 mm, such that L/TTL=0.30, the optical system 800 has a long back focus, facilitating assembly of the optical system 800.

Optionally, the maximal field-of-view FOV of the optical system 800 may be 26.5°, such that TTL/H/FOV*180°=21.6, which facilitates the miniaturization of the optical system 800.

Optionally, the radius of curvature of the side surface of the cylindrical lens 820 farther away from the lens assembly in the Y-axis direction is R=−570 mm, and R/Fy0=−16.88. By controlling the radius of curvature of the cylindrical lens 820, the Y-axis focal length of the entire system is reduced. The light beam emitted from the cylindrical lens 820 first converges and then diverges, causing the light spot to stretch and elongate, which is conducive to forming an elongated light spot with a more uniform distribution and higher encircled energy.

In some embodiments, the light spot formed by the aforementioned optical system 800, as shown in FIG. 12, is a strip-shaped light spot with a length of approximately 210 micrometers along the Y-axis. Compared to a circular light spot, the use of this optical system 800 results in higher space utilization for the photosensitive component 830.

### Embodiment 4

In some embodiments of the present disclosure, the optical system 800 may be as shown in FIG. 9. Here, the Y-axis focal length of the cylindrical lens 820 may be 2948.25 mm, an effective diameter of the cylindrical lens 820 may be 21 mm, and a center thickness of the cylindrical lens 820 may be 1.5 mm.

Optionally, the Y-axis focal length Fy1 of the cylindrical lens 820 may be 2948.25 mm, and the Y-axis focal length Fy2 of the lens assembly 810 may be 34.22 mm, such that |Fy1/Fy2|=86.17, which is conducive to forming a light spot that matches the photosensitive component 830.

Optionally, the distance d from the center of the side surface of the cylindrical lens 820 closer to the lens assembly 810 to the center of the side surface of the last lens in the lens assembly 810 closer to the cylindrical lens 820 on the optical axis of the optical system 800 may be 2 mm, such that Fy2/(Fy1*\sqrt{d})=0.0082, allowing the length of the light spot in the Y-axis direction to be controlled, thereby controlling the shape of the light spot on the image plane.

Optionally, the X-axis focal length Fx0 of the optical system 800 may be 34.22 mm, and the Y-axis focal length Fy0 of the optical system 800 may be 34.04 mm, Fx0/Fy0=1.005, such that the Y-axis focal length of the entire optical system 800 may be reduced, thereby forming a strip-shaped light spot. The cylindrical lens 820 is a convex surface, and in an optical path from the cylindrical lens 820 to the photosensitive component 830, the light beam first converges and then diverges, so that the light spot is stretched and lengthened, which may lead to a more uniform distribution of the light spot and a higher encircled energy.

Optionally, the maximum effective aperture D of the optical system 800 may be 21 mm, the image height H corresponding to the maximal field-of-view of the optical system 800 may be 16.05 mm, and the distance L from the center of the side surface of the cylindrical lens 820 farther away from the lens assembly 810 to the center of the image plane of the optical system 800 on the optical axis of the optical system 800 may be 15.08 mm, such that D*L/H=19.74. By controlling the size of the diameter of the cylindrical lens 820 and the back focal length, the included angle between light reaching the image plane and the optical axis is reduced, and a small CRA is realized.

Optionally, the X-axis focal length Fx0 of the optical system 800 may be 34.22 mm, and the entrance pupil diameter ENPD of the optical system 800 may be 24.3 mm, such that Fx0/ENPD=1.41, which is conducive to increasing the amount of incoming light, making the light spot on the imaging plane brighter.

Optionally, L may be 15.08 mm, and the distance TTL from the center of the side surface of the lens assembly 810 farther away from the cylindrical lens 820 to the image plane of the optical system 800 on the optical axis may be 49.93 mm, such that L/TTL=0.30, the optical system 800 has a long back focus, facilitating assembly of the optical system 800.

Optionally, the maximal field-of-view FOV of the optical system 800 may be 26.5°, such that TTL/H/FOV*180°=21.6, which facilitates the miniaturization of the optical system 800.

Optionally, the radius of curvature of the side surface of the cylindrical lens 820 farther away from the lens assembly in the Y-axis direction R=−1500 mm, AND R/Fy0=−44.06. By controlling the radius of curvature of the cylindrical lens 820, the Y-axis focal length of the entire system is reduced. The light beam emitted from the cylindrical lens 820 first converges and then diverges, causing the light spot to stretch and elongate, which is conducive to forming an elongated light spot with a more uniform distribution and higher encircled energy.

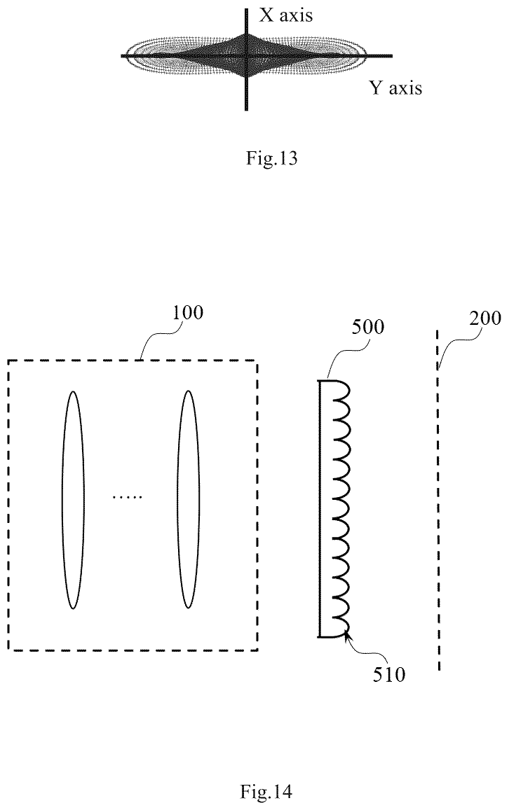

In some embodiments, the light spot formed by the optical system 800 described above, as shown in FIG. 13, is a strip-shaped light spot with a length of approximately 80 μm in the Y-axis direction. Compared to a circular light spot, the use of this optical system 800 results in higher space utilization for the photosensitive component 830.

It should be understood that the structural parameters of the optical system 800 are illustrated exemplarily in Embodiment 3 and Embodiment 4, and in other embodiments, the optical system 800 may also adopt other structural parameters, which is not limited in the present disclosure.

As can be seen from Embodiment 3 and Embodiment 4, by adjusting the structural parameters of the cylindrical lens 820 and the structure of the optical system 800, the shape of the light spot on the photosensitive component 830 and the length in the Y-axis direction may be controlled, which is conducive to matching the photosensitive component 830 and improving the space utilization rate of the photosensitive component 830.

The embodiment of the present disclosure also provides a LiDAR device, which may include a radar receiving end. The radar end may include an optical system 800 as exemplified in FIG. 8 or FIG. 9, for receiving reflected light from the detected object. By placing a cylindrical lens 820 on the light exit side of the lens assembly 810, the focal lengths along the X-axis and Y-axis of the optical system 800 can be adjusted, thereby altering the shape of the light spot and enhancing the spatial utilization of the photosensitive component 830. Furthermore, utilizing a cylindrical lens 820 to adjust the shape of the light spot involves less processing difficulty, lower costs, and is easier to achieve mass production.

In some embodiments of the present disclosure, the cylindrical lens 820 may be a convex cylindrical lens, which first converges and then diverges the light beam, stretching and elongating the light spot, thereby achieving a more uniform distribution of the light spot and a higher encircled energy. Compared to a concave cylindrical lens, under the condition of the same spot length, the optical system 800 utilizing a convex cylindrical lens produces a light spot with higher energy than the optical system 800 using a concave cylindrical lens.

As an option, the cylindrical lens 820 may be, as shown in FIG. 10 a convex cylindrical lens with a convex surface in the Y-axis direction. Optionally, the Y-axis direction is parallel to a extension direction of a long side of a photosensitive area of the photosensitive component, and the X-axis direction is perpendicular to the Y-axis direction. For example, the Y-axis direction and the X-axis direction may be referenced as shown in FIG. 10. The light spot formed by the optical system 800 using this cylindrical lens 820 is shown in FIG. 11. Due to the convex surface formed by the cylindrical lens in the Y-axis direction, the focal length of the cylindrical lens in the Y-axis direction is reduced, causing the focal point on the Y-axis to be positioned before the imaging plane. The light beam first converges and then diverges, stretching and elongating the light spot, which results in a more uniform light spot distribution and higher encircled energy.

It should be understood that without departing from the teachings of the present disclosure, the convex cylindrical lens may also form a convex surface in other directions, which is not limited in the present disclosure.

As an option, the convex cylindrical lens may include a plano-convex cylindrical lens or a biconvex cylindrical lens. The focal length of the optical system 800 may be adjusted by the plano-convex cylindrical lens or the biconvex cylindrical lens to change the shape of the light spot, thereby improving the space utilization rate of the photosensitive component 830.

It should be understood that other types of convex cylindrical lenses may also be used in other embodiments without departing from the teachings of the present disclosure, which is not limited in the present disclosure.

As an option, referring to FIG. 9, a convex surface of the convex cylindrical lens is a surface that faces away from the lens assembly 810. It should be understood that without departing from the arrangement of the convex cylindrical lens may be adjusted as needed, which is not limited in the present disclosure.

In some embodiments of the present disclosure, a Y-axis focal length Fy1 of the cylindrical lens 820, a Y-axis focal length Fy2 of the lens assembly, and a distance d from the center of the side surface of the cylindrical lens 820 closer to the lens assembly 810 to a center of a side surface of a last lens in the lens assembly 810 closer to the cylindrical lens 820 on the optical axis of the optical system 800 satisfy: Fy2/(Fy1*\sqrt{d})≥0.005. Optionally, Fy1, Fy2, and d satisfy: 0.005≤Fy2/(Fy1*\sqrt{d})≤0.05. Optionally, Fy1, Fy2, and d satisfy: 0.006≤Fy2/(Fy1*\sqrt{d})≤0.028. Optionally, by altering the radius of curvature of the cylindrical lens 820 along the Y-axis, the focal length along the Y-axis is changed, resulting in different focal lengths along the X-axis and Y-axis of the optical system 800. Additionally, by adjusting the distance between the cylindrical lens 820 and the lens assembly 810, the length of the light spot along the Y-axis is jointly controlled, thereby managing the shape of the light spot on the imaging plane.

In some embodiments of the present disclosure, the Y-axis focal length Fy1 of the cylindrical lens 820 and the Y-axis focal length Fy2 of the lens assembly 810 satisfy: |Fy1/Fy2|≥10. Optionally, Fy1 and Fy2 satisfy: 15≤|Fy1/Fy2|≤90. In this example, By modifying the radius of curvature of the cylindrical lens 820 along the Y-axis, the focal length along the Y-axis is adjusted, causing the optical system 800 to have different focal lengths along the X-axis and Y-axis. This results in the formation of a strip-shaped light spot, which is advantageous for creating a light spot that is compatible with the photosensitive component 830.

In some embodiments of the present disclosure, the X-axis focal length Fx0 and the Y-axis focal length Fy0 of the optical system 800 satisfy: Fx0/Fy0≥1.002. Optionally, Fx0 and Fy0 satisfy: Fx0/Fy0≥1.004. This embodiment allows for the reduction of the focal length of the entire optical system 800 along the Y-axis by controlling the radius of curvature of the cylindrical lens 820, thereby forming a strip-shaped light spot. The cylindrical lens is convex, and in the optical path from the cylindrical lens to the photosensitive component, the light beam first converges and then diverges, stretching and elongating the light spot, which can result in a more uniform distribution of the light spot and higher encircled energy.

In some embodiments of the present disclosure, a maximum effective aperture D of the optical system 800, an image height H corresponding to a maximal field-of-view of the optical system 800, and a distance L from the center of the side surface of the cylindrical lens 820 farther away from the lens assembly 810 to a center of the image plane of the optical system 800 on the optical axis of the optical system 800 satisfy: D*L/H≥5 mm. Optionally, D, H and L satisfy: 8 mm≤D*L/H≤20 mm. By controlling a size of the diameter of the cylindrical lens 820 and the back focal length, an included angle between light reaching the image plane and the optical axis is reduced, and a small CRA is realized.

In some embodiments of the present disclosure, the X-axis focal length Fx0 and an entrance pupil diameter ENPD of the optical system 800 satisfy: Fx0/ENPD≤2. Optionally, F and ENPD satisfy: 1.1≤Fx0/ENPD≤1.6. By controlling the ratio of the focal length Fx0 to the entrance pupil diameter ENPD to realize a small FNO, it is conducive to increasing the amount of incoming light. By increasing the amount of incoming light, the light spot on the image plane may be brighter.

In some embodiments of the present disclosure, the distance L from the center of the side surface of the cylindrical lens 820 farther away from the lens assembly 810 to the center of the image plane of the optical system 800 on the optical axis of the optical system 800, and a distance TTL from a center of a side surface of the lens assembly 810 farther away from the cylindrical lens 820 to the image plane of the optical system 800 on the optical axis satisfy: L/TTL≥0.1. Optionally, L and TTL satisfy: L/TTL≥0.12. This embodiment allows for a long back focal length of the optical system 800, providing space for the mounting and focusing of optical components, avoiding interference between components, and facilitating the assembly of the optical system 800.

In some embodiments of the present disclosure, the distance TTL from the center of the side surface of the lens assembly 810 farther away from the cylindrical lens 820 to the image plane of the optical system 800 on the optical axis, the maximal field-of-view FOV of the optical system 800 and the image height H corresponding to the maximal field-of-view satisfy: TTL/H/FOV*180°≤54. Optionally, TTL, H, and FOV satisfy: TTL/H/FOV*180°≤27. With the same ratio of the image height to the field-of-view, this embodiment may effectively limit the length of the optical system 800, which is conducive to realizing miniaturization of the optical system 800.

As shown in FIG. 14, the embodiment of the present disclosure provides an optical system that includes a lens group 100 and a microstructure array 500 positioned on the transmission optical path of the lens group 100. The microstructure array 500 includes multiple microstructures 510 distributed along a first direction and a second direction, where the first direction and the second direction have an angle between them; and the optical parameters of the microstructures 510 along the first direction satisfy preset conditions, such that the focal length of the optical system along the first direction is smaller than the focal length of the optical system along the second direction. The optical parameters include focal length and/or radius of curvature.

As can be seen from the above, the embodiment of the present disclosure achieves a reduction in the focal length of the entire optical system along a first direction by arranging a microstructure array 500 on the transmission optical path of the lens group 100 and ensuring that the optical parameters of the microstructures 510 in the microstructure array 500 along the first direction meet preset conditions. This results in the focal length of the optical system along the first direction being smaller than that along a second direction. External light rays pass through the lens group 100 and then are directed towards the microstructure array 500. The light rays passing through the microstructures 510 first converge and then diverge, ultimately forming a light spot that is elongated along the first direction. In other words, the light spot formed on the imaging plane 200 of the optical system is elongated in a strip shape along the first direction. Consequently, when the optical system of this embodiment is applied to an optical module, it not only enhances the utilization rate of the photosensitive area of the photosensitive chip 300 but also does not compromise the energy of the light spot. Furthermore, the microstructure array 500 is easy to process, cost-effective, and conducive to mass production.

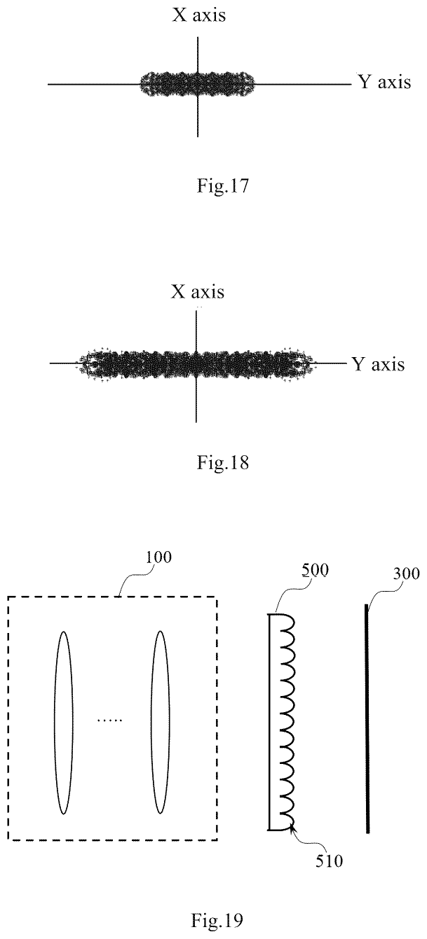

It should be noted that the optical system in the embodiments of the present disclosure may be, but is not limited to, a receiving end of a lidar. Additionally, the first direction and the second direction may be perpendicular to each other or not. For example, as shown in FIGS. 17, 18, 20, and 22, the first direction is the y-axis direction, and the second direction is the x-axis direction. As another example, there may be an acute or obtuse angle between the first direction and the second direction. Furthermore, the microstructures 510 may be micro-lenses or nanostructures on a nanoimprint film. For instance, the microstructure array 500 includes a substrate 520 and multiple micro-lenses arranged in an array on at least one side of the substrate 520. As another example, the microstructure array 500 includes a substrate 520 and a nanoimprint film formed on at least one side of the substrate 520. Moreover, the lens group 100 may include one or more lenses. When the lens group 100 includes multiple lenses, the lenses are sequentially spaced apart along the optical axis from the object side to the image side. The lenses may be glass lenses or plastic lenses. If the operating ambient environment temperature is high and there are high requirements for image resolution quality, glass lenses may be selected.

In some embodiments, the focal length Fy0 of the optical system in the first direction and the focal length Fx0 of the optical system in the second direction satisfy: Fx0/Fy0≥1.01. Further, Fx0/Fy0≥1.05. For example, the value of Fx0/Fy0 may be 1.06, 1.07, 1.08 or 1.09.

The present disclosure may make the focal length of the optical system in the first direction smaller than the focal length of the optical system in the second direction by limiting a focal length and/or a radius of curvature of the microstructure 510 in the first direction. The preset conditions that the focal length or radius of curvature of the microstructure 510 in the first direction should satisfy may include, but are not limited to, at least one of the following.

First, a focal length Fy1 of the microstructure 510 in the first direction and a focal length Fy2 of the lens group 100 in the first direction satisfy: |Fy1/Fy2|≥1.1. Further, 1.2≤|Fy1/Fy2|≤6. For example, the value of Fy1/Fy2 may be 2.5, 3.5, 4.5 or 5.5. In this embodiment, by controlling the focal lengths of the microstructures 510 and the lens group 100 along the first direction through the aforementioned conditional expressions, the focal length of the optical system along the first direction is reduced, making the focal length along the first direction smaller than the focal length along the second direction, which results in external light rays forming an elongated light spot extending along the first direction on the imaging plane 200 after passing through the optical system. It should be noted that the focal length of the microstructures 510 along the first direction may be controlled by limiting the radius of curvature, material, or thickness of the microstructures 510.

Second, the focal length Fy1 of the microstructures 510 along the first direction, the focal length Fy2 of the lens group 100 along the first direction, and the air spacing d between the lens group 100 and the microstructure array 500 satisfy the condition: 0.10≤Fy2/(Fy1*SQRT(d))). Furthermore, the range may be 0.10≤Fy2/(Fy1*SQRT(d)))≤1.15. As an example, 0.13≤Fy2/(Fy1*SQRT(d))≤0.57, and the value of Fy2/(Fy1*SQRT(d)) may be 0.2, 0.3, 0.4, or 0.5. In the embodiment of the present disclosure, by controlling the focal lengths of the microstructures 510 and the lens group 100 along the first direction and the air spacing between the lens group and the microstructure array 500 through the aforementioned conditional expression, the focal length of the optical system along the first direction may also be reduced, making the focal length along the first direction smaller than the focal length along the second direction, which results in external light rays forming a strip-shape light spot extending along the first direction on the imaging plane 200 after passing through the optical system.

Third, the microstructure array 500 includes a substrate 520 and multiple microstructures 510, with the microstructures 510 arranged in an array on the side of the substrate 520 facing the lens group 100 and/or on the side of the substrate 520 facing away from the lens group 100. Along the optical axis direction of the lens group 100, the microstructures 510 have a convex surfaces protruding toward a direction away from the substrate 520. The radius of curvature R of the convex surface of the microstructures 510 along the first direction and the focal length Fy0 of the optical system along the first direction satisfy the condition: |R/Fy0|≥0.5. Furthermore, the range may be 0.5≤|R/Fy0|≤5. For example, the value of R/Fy0 may be 1, 1.5, 2, 2.5, 3, 3.5, 4, or 4.5. In the embodiment of the present disclosure, by controlling the radius of curvature of the convex surface of the microstructures 510 along the first direction and the focal length of the optical system along the first direction through the aforementioned conditional expressions, the focal length of the optical system along the first direction may also be reduced, making the focal length along the first direction smaller than the focal length along the second direction, which results in external light rays forming a strip-shape light spot extending along the first direction on the imaging plane 200 after passing through the optical system.

In some embodiments, a maximal diameter D of the microstructure array 500, an image height H corresponding to a maximal field-of-view of the optical system, and a distance L between a center of an image-side surface of the microstructure array 500 and a center of the image plane 200 of the optical system satisfy: D*L/H≥5. Further, the range is 10≤D*L/H≤25. For example, the value of D*L/H may be 13, 16, 19, 21 or 24. By controlling, with the above conditional expressions, the maximal diameter of the microstructure array 500, the image height corresponding to the maximal field-of-view of the optical system, and the distance between the center of the image-side surface of the microstructure array 500 and the center of the image plane 200 of the optical system, an embodiment of the present disclosure may not only control a size of the microstructure array within a reasonable range, but also increase a back focal length of the optical system, so as to reduce an included angle between light reaching the image plane 200 and the optical axis, thus realizing a small CPA (Chief Ray Angle).

In some embodiments, a focal length F of the optical system and an entrance pupil diameter ENPD of the optical system satisfy: F/ENPD≤2. Further, the range is 1.1≤F/ENPD≤1.6. For example, the value of F/ENPD may be 1.2, 1.3, 1.4, or 1.5. By controlling the focal length and the entrance pupil diameter of the optical system, an embodiment of the present disclosure may realize a small FNO, i.e., F/ENPD, increasing admitted light of the optical system, so that a strip-shaped light spot formed on the image plane 200 is brighter.

In some embodiments, the distance L between the center of the image-side surface of the microstructure array 500 and the center of the image plane 200 of the optical system and a total track length TTL of the optical system satisfy: L/TTL≥0.1. Further, the range is L/TTL≥0.2. For example, the value of L/TTL may be 0.25, 0.3, 0.35, or 0.4. By controlling the distance between the center of the image-side surface of the microstructure array 500 and the center of the image plane 200 of the optical system and the total track length of the optical system, an embodiment of the present disclosure may increase the back focal length of the optical system, which not only reserves space for the mounting and focusing of optical components such as the lenses and the microstructure array 500, thereby facilitating the assembly of the optical system 100, but also avoids interference between optical components.

In some embodiments, the total track length TTL of the optical system, the maximal field-of-view FOV of the optical system, and the image height H corresponding to the maximal field-of-view of the optical system satisfy: TTL/H/FOV≤0.3. Further, the range is TTL/H/FOV≤0.15. For example, the value of TTL/H/FOV may be 0.12, 0.1, 0.08, or 0.06. By controlling the total track length of the optical system, the maximal field-of-view of the optical system, and the image height corresponding to the maximal field-of-view of the optical system, an embodiment of the present disclosure may reduce the total track length of the optical system while the ratio of the maximal field-of-view of the optical system to the image height corresponding to the maximal field-of-view remains unchanged, thereby realizing miniaturization of the optical system.

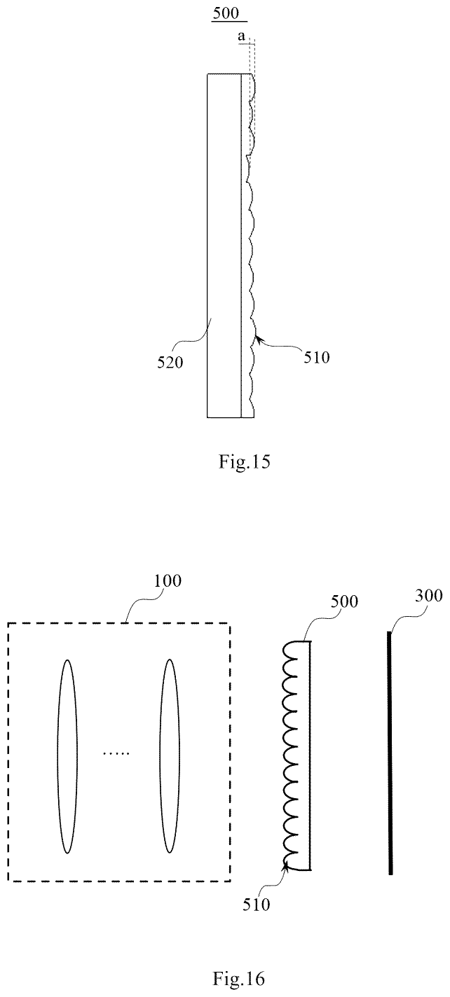

In some embodiments, as shown in FIG. 15, in multiple microstructures 510, at least two of them have different thicknesses along the optical axis direction. In other words, not all microstructures 510 in the microstructure array 500 have the same thickness; at least one of the microstructures 510 has the maximum thickness, and at least one of the microstructures 510 has the minimum thickness. For example, some microstructures 510 have the maximum thickness, while others have the minimum thickness, and the remaining microstructures 510 have intermediate thicknesses between the maximum and minimum. As another example, the majority of microstructures 510 may have the maximum thickness, while the remaining minority have the minimum thickness. As an illustration, the difference ‘a’ between the maximum and minimum thicknesses of the microstructures 510 is no greater than 0.1 mm. Compared to a microstructure array 500 where all microstructures 510 have the same thickness, the embodiment of the present disclosure achieves randomization of the thicknesses of the microstructures 510 by making at least two microstructures 510 in the microstructure array 500 have different thicknesses along the optical axis direction, which can eliminate diffraction caused by the microstructures 510 themselves and improve imaging quality.

Further, as shown in FIG. 16, FIG. 19 and FIG. 21, an embodiment of the present disclosure also provides an optical module, and the optical module includes the photosensitive chip 300 and the optical system described above. Here, a size of the photosensitive chip 300 in the first direction is larger than a size of the photosensitive chip 300 in the second direction, the photosensitive chip 300 is disposed on the image plane 200 of the optical system, and the image plane 200 is disposed on a side of the microstructure array 500 of the optical system farther away from the lens group 100.

Since the optical system in an embodiment of the present disclosure is provided with the microstructure array 500, and the optical parameters of the microstructures 510 of the microstructure array 500 in the first direction satisfy the preset condition, the focal length of the optical system in the first direction is smaller than the focal length of the optical system in the second direction. Consequently, external light rays pass through the lens group 100 and are directed to the microstructure array 500. The light rays passing through the microstructures 510 first converge and then diverge, ultimately forming a light spot that is elongated along the first direction. In other words, the light spot formed on the photosensitive chip 300 is elongated in the shape of a strip along the first direction. Moreover, the size of the photosensitive chip 300 along the first direction is larger than the seize of the photosensitive chip 300 along the second direction. That is, the shape of the light spot is compatible with the shape of the photosensitive chip 300. Therefore, both along the first direction and along the second direction, almost the entire photosensitive area of the photosensitive chip 300 is illuminated by the light spot, which not only improves the utilization rate of the photosensitive area of the photosensitive chip 300 but also does not affect the energy of the light spot.

Examples of the optical module in different structural forms in the embodiments of the present disclosure are described below.

### Embodiment 5

As shown in FIG. 16 and FIG. 17, an optical module in the present embodiment includes an optical system and a photosensitive chip 300, the optical system includes a lens group 110 and a microstructure array 500, the microstructure array 500 is disposed on a transmission optical path of the lens group 100, and the photosensitive chip 300 is positioned on a side of the microstructure array 500 farther away from the lens group 100 and on an image plane 200 of the optical system. A size of the photosensitive chip 300 in a first direction is larger than a size of the photosensitive chip 300 in the second direction, the microstructure array 500 includes a substrate 520 and multiple microstructures 510, the multiple microstructures 510 are distributed in an array along the first direction and the second direction on a side of the substrate 520 facing the lens group 100. Along a direction of an optical axis of the lens group 100, a surface of the microstructure 510 facing the lens group 100, i.e., an object-side surface, is a convex surface protruding in a direction facing away from the substrate 520; and an optical parameter of the microstructure 510 in the first direction satisfies a preset condition, such that a focal length of the optical system in the first direction is smaller than a focal length of the optical system in the second direction, and the optical parameter includes a focal length and/or a radius of curvature, and the first direction and the second direction have an included angle between them.

Further, in the present embodiment, at least two of the microstructures 510 in the multiple microstructures 510 have different thicknesses in the direction of the optical axis, and a difference ‘a’ between a maximum thickness of the microstructures 510 and a minimum thickness of the microstructures 510 is not greater than 0.1 mm. Compared to a microstructure array 500 in which all the microstructures 510 have a given thickness, the present embodiment realizes randomization of the thicknesses of the microstructures 510 by making at least two of the microstructures 510 in the microstructure array 500 have different thicknesses in the direction of the optical axis, which may eliminate diffraction caused by the microstructures 510 themselves and improve an imaging quality.

Table 4 below illustrates a focal length Fy1 of the microstructure 510 in the first direction, a focal length Fy2 of the lens group 100 in the first direction, an air spacing d between the lens group 100 and the microstructure array 500, a radius of curvature R of the object-side surface of the microstructure 510 in the first direction, a maximal diameter D of the microstructure array 500, an image height H corresponding to a maximal field-of-view of the optical system, a distance L between a center of an image-side surface of the microstructure array 500 and a center of the image plane 200 of the optical system, a focal length F of the optical system, an entrance pupil diameter ENPD of the optical system, a total track length TTL of the optical system, the maximal field-of-view FOV of the optical system, the focal length Fy0 of the optical system in the first direction, the focal length Fx0 of the optical system in the second direction and a length Ly of a strip-shaped light spot in the first direction in Embodiment 5.

TABLE 4

| parameter | Fy1(mm) | Fy2(mm) | d(mm) | R(mm) | D(mm) | H(mm) |
|---|---|---|---|---|---|---|
| value | 98.28 | 34.22 | 2 | 50 | 21 | 16.05 |

| parameter | L(mm) | F(mm) | ENPD(mm) | TTL(mm) | FOV(°) | Fy0(mm) |
|---|---|---|---|---|---|---|
| value | 15.73 | 34.22 | 24.3 | 49.58 | 26.5 | 29.39 |

| parameter | Fx0(mm) | Ly(um) |
|---|---|---|
| value | 34.22 | about 110 |

### Embodiment 6

As shown in FIG. 15 and FIG. 18, a structure of an optical module in the present embodiment is basically the same as the structure of the optical module in Embodiment 5, for the part which is the same as that of Embodiment 5, detailed description thereof will be omitted in the present embodiment, and the differences are: a focal length Fy1 of the microstructure 510 in the first direction is 45.21 mm, a radius of curvature R of the object-side surface of the microstructure 510 in the first direction is 23 mm, the focal length Fy0 of the optical system in the first direction is 25.22 mm, and a length Ly of a strip-shaped light spot in the first direction is about 220 um.

Table 5 below illustrates the focal length Fy1 of the microstructure 510 in the first direction, a focal length Fy2 of the lens group 100 in the first direction, an air spacing d between the lens group 100 and the microstructure array 500, the radius of curvature R of the object-side surface of the microstructure 510 in the first direction, a maximal diameter D of the microstructure array 500, an image height H corresponding to a maximal field-of-view of the optical system, a distance L between a center of an image-side surface of the microstructure array 500 and a center of the image plane 200 of the optical system, a focal length F of the optical system, an entrance pupil diameter ENPD of the optical system, a total track length TTL of the optical system, the maximal field-of-view FOV of the optical system, the focal length Fy0 of the optical system in the first direction, the focal length Fx0 of the optical system in the second direction and the length Ly of the strip-shape light spot in the first direction in Embodiment 6.

TABLE 5

| parameter | Fy1(mm) | Fy2(mm) | d(mm) | R(mm) | D(mm) | H(mm) |
|---|---|---|---|---|---|---|
| value | 45.21 | 34.22 | 2 | 23 | 21 | 16.05 |

| parameter | L(mm) | F(mm) | ENPD(mm) | TTL(mm) | FOV(°) | Fy0(mm) |
|---|---|---|---|---|---|---|
| value | 15.73 | 34.22 | 24.3 | 49.58 | 26.5 | 25.22 |

| parameter | Fx0(mm) | Ly(um) |
|---|---|---|
| value | 34.22 | about 220 |

### Embodiment 7

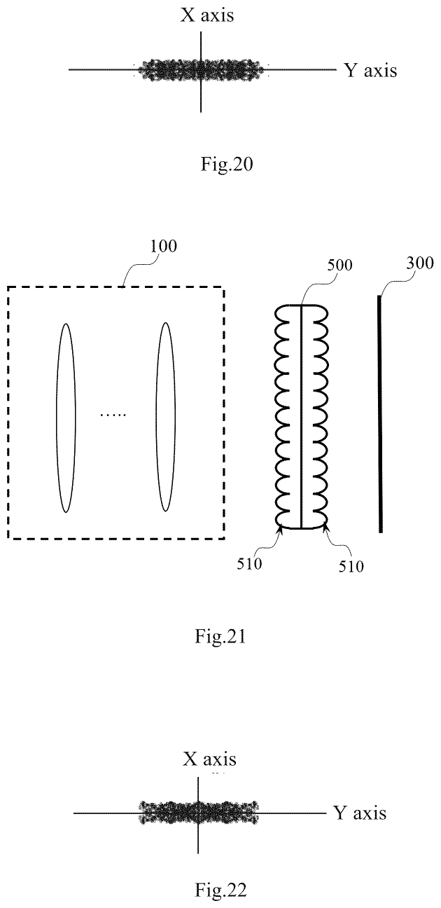

As shown in FIGS. 19 and 20, the optical module in this embodiment has a structure that is basically identical to the optical module in Embodiment 5. This embodiment will not repeat the description of the parts that are the same as those in Embodiment 5. The difference lies in the following: the microstructure array 500 includes a substrate 520 and multiple microstructures 510. The microstructures 510 are arranged in an array along both the first direction and the second direction on the side of the substrate 520 facing away from the lens assembly 100. Along the direction of the optical axis of the lens assembly 100, the surface of the microstructure 510 facing towards the photosensitive chip 300, also known as the image-side surface, is a convex surface protruding towards a direction facing from the substrate 520. The focal length Fy1 of the microstructure 510 along the first direction is 78.62 mm, the focal length Fy0 of the optical system along the first direction is 28.49 mm, the radius of curvature R of the image-side surface of the microstructure 510 along the first direction is −40 mm, and the length Ly of the strip-shaped light spot along the first direction is approximately 140 μm.

Table 6 below illustrates the focal length Fy1 of the microstructure 510 in the first direction, a focal length Fy2 of the lens group 100 in the first direction, an air spacing d between the lens group 100 and the microstructure array 500, the radius of curvature R of the image-side surface of the microstructure 510 in the first direction, a maximal diameter D of the microstructure array 500, an image height H corresponding to a maximal field-of-view of the optical system, a distance L between a center of an image-side surface of the microstructure array 500 and a center of the image plane 200 of the optical system, a focal length F of the optical system, an entrance pupil diameter ENPD of the optical system, a total track length TTL of the optical system, the maximal field-of-view FOV of the optical system, the focal length Fy0 of the optical system in the first direction, the focal length Fx0 of the optical system in the second direction and the length Ly of the strip-shape light spot in the first direction in Embodiment 7.

TABLE 6

| parameter | Fy1(mm) | Fy2(mm) | d(mm) | R(mm) | D(mm) | H(mm) |
|---|---|---|---|---|---|---|
| value | 78.62 | 34.22 | 2 | −40 | 21 | 16.05 |

| parameter | L(mm) | F(mm) | ENPD(mm) | TTL(mm) | FOV(°) | Fy0(mm) |
|---|---|---|---|---|---|---|
| value | 15.73 | 34.22 | 24.3 | 49.58 | 26.5 | 28.49 |

| parameter | Fx0(mm) | Ly(um) |
|---|---|---|
| value | 34.22 | about 140 |

### Embodiment 8

As shown in FIGS. 21 and 22, the optical module in this embodiment has a structure that is basically identical to the optical module in Embodiment 5. This embodiment will not repeat the parts that are the same as Embodiment 5. The differences lie in the following: The microstructure array 500 includes a substrate 520 and multiple microstructures 510. Both the side of the substrate 520 facing the lens group 100 and the side of the substrate 520 facing away from the lens group 100 have multiple microstructures 510 arranged in an array along a first direction and a second direction. The object-side surface of the microstructures 510 located between the substrate 520 and the lens group 100, which faces the lens group 100, is a convex surface protruding towards a direction facing away from the substrate 520 along the optical axis direction. The image-side surface of the microstructures 510 located between the substrate 520 and the photosensitive chip 300, which faces the photosensitive chip 300, is also a convex surface protruding towards a direction facing away from the substrate 520 along the optical axis direction. The focal length Fy1 of the microstructures 510 along the first direction is 67.47 mm, the focal length Fy0 of the optical system along the first direction is 28.00 mm, the distance L between the center of the image-side surface of the microstructure array 500 and the center of the imaging plane 200 of the optical system is 14.73 mm, the image height H corresponding to the maximum field of view of the optical system is 16.04 mm, the curvature radii R of the object-side surface of the microstructures 510 located between the substrate 520 and the lens group 100 and the image-side surface of the microstructures 510 located between the substrate 520 and the photosensitive chip 300 along the first direction are 60 mm and −80 mm, respectively, the air spacing d between the lens group 100 and the microstructure array 500 is 3 mm, and the length Ly of the strip-shaped light spot along the first direction is approximately 130 μm.

Table 7 below illustrates the focal length Fy1 of the microstructure 510 in the first direction, a focal length Fy2 of the lens group 100 in the first direction, the air spacing d between the lens group 100 and the microstructure array 500, the radius of curvature R of the object-side surface of the microstructure 510 disposed between the substrate 520 and the lens group 100 in the first direction, the radius of curvature R of the image-side surface of the microstructure 510 disposed between the substrate 520 and the photosensitive chip 300 in the first direction, a maximal diameter D of the microstructure array 500, the image height H corresponding to the maximal field-of-view of the optical system, the distance L between the center of the image-side surface of the microstructure array 500 and the center of the image plane 200 of the optical system, a focal length F of the optical system, an entrance pupil diameter ENPD of the optical system, a total track length TTL of the optical system, the maximal field-of-view FOV of the optical system, the focal length Fy0 of the optical system in the first direction, the focal length Fx0 of the optical system in the second direction and the length Ly of the strip-shape light spot in the first direction in Embodiment 8.

TABLE 7

| parameter | Fy1(mm) | Fy2(mm) | d(mm) | R/object side(mm) | R/image side(mm) | D(mm) |
|---|---|---|---|---|---|---|
| value | 67.47 | 34.22 | 3 | 60 | −80 | 21 |

| parameter | L(mm) | F(mm) | ENPD(mm) | TTL(mm) | FOV(°) | Fy0(mm) |
|---|---|---|---|---|---|---|
| value | 14.73 | 34.22 | 24.3 | 49.58 | 26.5 | 28.00 |

| parameter | Fx0(mm) | Ly(um) | H(mm) |
|---|---|---|---|
| value | 34.22 | about 130 | 16.04 |

In summary, Embodiment 5 to Embodiment 8 satisfy the relationships shown in Table 8 below.

TABLE 8

| | embodiment | | | |
|---|---|---|---|---|
| conditional | embodi- | embodi- | embodi- | embodi- |
| expression | ment 5 | ment 6 | ment 7 | ment 8 |
| \|Fy1/Fy2\| | 2.87 | 1.32 | 2.30 | 1.97 |
| Fy2/(Fy1*SQRT(d)) | 0.25 | 0.54 | 0.31 | 0.29 |
| \|R/Fy0\| | 1.70 | 0.91 | 1.40 | 2.14 (object |
| | | | | side |
| | | | | 2.86 (image |
| | | | | side |
| Fx0/Fy0 | 1.16 | 1.36 | 1.20 | 1.22 |
| D*L/H | 20.59 | 20.59 | 20.59 | 19.28 |
| F/ENPD | 1.41 | 1.41 | 1.41 | 1.41 |
| L/TTL | 0.32 | 0.32 | 0.32 | 0.30 |
| TTL/H/FOV | 0.12 | 0.12 | 0.12 | 0.12 |

According to Table 8, it can known that |Fy1/Fy2|≥1.1, 0.10≤Fy2/(Fy1*SQRT(d))), |R/Fy0|≥0.5 in Embodiment 5 to Embodiment 8. By respectively controlling the relative magnitudes of the focal lengths of the microstructure 510 and the lens group 100 in the first direction, the relative magnitudes of the focal lengths of the microstructure 510 and the lens group 100 in the first direction and the relative magnitude of the air spacing between the lens group and the microstructure array 500, the relative magnitudes of the radius of curvature of the convex surface of the microstructure 510 in the first direction and the relative magnitude of the focal length of the optical system in the first direction through the above three conditional expressions, the present disclosure may reduce the focal length of the optical system in the first direction, such that the focal length of the optical system in the first direction is smaller than the focal length of the optical system in the second direction, so that external light forms a strip-shaped light spot extending in the first direction on the image plane 200 after passing through the optical system.

In addition, according to Table 8, it can also be seen that D*L/H≥5, F/ENPD≤2, L/TTL≥0.1, and TTL/H/FOV≤0.3. It can be seen that in the present disclosure a size of the microstructure array 500 is within a reasonable range, and in the case where D*L/H≥5, the optical system has a long back focal length, thereby reducing an included angle between light reaching the image plane 200 and the optical axis, and realizing a small CRA; and in the case where F/ENPD≤2, a small FNO may be realized, increasing admitted light of the optical system, and improving brightness of a strip-shaped light spot; in the case where L/TTL≥0.1, the back focal length of the optical system may be increased, reserving space for mounting and focusing of optical elements such as lenses and the microstructure array 500; in the case where TTL/H/FOV≤0.3, the total track length of the optical system may be reduced while the ratio of the maximal field-of-view of the optical system to the image height corresponding to the maximal field-of-view remains unchanged, thereby realizing miniaturization of the optical system.

In addition, an embodiment of the present disclosure also provides a method for mounting an optical module, the method including:
S110, sequentially assembling, in a direction from an object side to an image side of a lens barrel, a microstructure array 500 and a lens group 100 into the lens barrel to form an optical system;
S220, fixing a photosensitive chip 300 to a board surface of a circuit board; and
S300, fixing the lens barrel to the circuit board, and positioning the lens barrel to cover the photosensitive chip 300;
where the microstructure array 500 includes multiple microstructures distributed along a first direction and a second direction. The optical parameters of the microstructures along the first direction satisfy preset conditions, such that the focal length of the optical system along the first direction is smaller than the focal length of the optical system along the second direction. The optical parameters include focal length and/or radius of curvature. The photosensitive chip 300 has a size along the first direction that is greater than its size along the second direction, and the first direction and the second direction have an included angle between them.

The above description is merely an embodiment of the present disclosure and an explanation of the technical principles applied. Those skill in the art should understand that the scope of protection involved in the present disclosure is not limited to the technical solution formed by the specific combination of the aforementioned technical features. It should also encompass other technical solutions formed by any combination of the aforementioned technical features or their equivalent features without departing from the technical concept, such as, but not limited to, technical solutions formed by substituting the aforementioned features with technical features that have similar functions disclosed in the present disclosure.

What is claimed is:

1. An optical system, comprising:
a lens group, arranged sequentially along an optical axis from an object side to an image side; and
an optical element, disposed on a transmission optical path of the lens group, the optical element having different focal lengths in a first direction and a second direction;
wherein the first direction and the second direction have an included angle therebetween and are both perpendicular to the optical axis, and a focal length of the optical system in the first direction is different from a focal length of the optical system in the second direction.

2. The optical system according to claim 1, wherein a light spot formed on an imaging plane by external light sequentially passing through the lens group and the optical element is a strip-shaped light spot extending in the first direction.

3. The optical system according to claim 1, wherein the optical element comprises a free-form surface lens; and
an optical parameter of the free-form surface lens in the first direction satisfies a preset condition, such that the focal length of the optical system in the first direction is smaller than the focal length of the optical system in the second direction.

4. The optical system according to claim 3, wherein the free-form surface lens is a lens close to the image side, and an image-side surface of the free-form surface lens is a free-form surface.

5. The optical system according to claim 4, wherein the optical parameter comprises a radius of curvature of the free-form surface, and the preset condition comprises a radius of curvature Ry of the free-form surface in the first direction, a radius of curvature Rx of the free-form surface in the second direction, the focal length Fy0 of the optical system in the first direction, a focal length Fy1 of the free-form surface in the first direction, a focal length Fx1 of the free-form surface in the second direction, the focal length Fx0 of the optical system in the second direction, a maximum effective aperture D of the optical system, a distance L between a center of the free-form surface and a center of the image plane of the optical system, an image height H corresponding to a maximal field-of-view of the optical system, a total track length TTL of the optical system, a sag SAGy of the free-form surface in the first direction, a sag SAGx of the free-form surface in the second direction, satisfying at least one of following conditions:
$$\vert Ry / Rx \vert \geq 1.02 ;$$
$$Ry / Fy \geq 1 ;$$
$$\vert Fy 1 / Fy 0 \vert \geq 0.5 ;$$
$$1.003 \leq Fx 1 / Fy 1 ;$$
$$Fx 0 / Fy 0 \geq 1.005 ;$$
$$20 \leq D * L / H \leq 35 ;$$
$$TTL / [ ( SAGx + SAGy ) / 2 ] \geq 40 ; and$$
$$0.2 \leq L / Fx 0 \leq 1.$$

6. The optical system according to claim 1, wherein a maximum effective aperture D of the optical system, a distance L between a center of an image-side surface of the optical element and a center of an image plane of the optical system, and an image height H corresponding to a maximal field-of-view of the optical system satisfy:
$$D * L / H \geq 5.$$

7. The optical system according to claim 1, wherein a focal length F of the optical system and an entrance pupil diameter ENPD of the optical system satisfy:
$$F / ENPD \leq 2.$$

8. The optical system according to claim 1, wherein a distance L between a center of an image-side surface of the optical element and a center of an image plane of the optical system, and a total track length TTL of the optical system satisfy:
$$L / TTL \geq 0.1 .$$

9. The optical system according to claim 1, wherein a total track length TTL of the optical system, a maximal field-of-view FOV of the optical system, and an image height H corresponding to a maximal field-of-view of the optical system satisfy TTL/H/FOV≤0.3.

10. The optical system according to claim 1, wherein the optical element comprises a cylindrical lens, at least one of a surface of the cylindrical lens facing the lens group and a surface of the cylindrical lens facing away from the lens group is a cylindrical surface, such that a focal length of the cylindrical lens in the first direction is smaller than a focal length of the cylindrical lens in the second direction;
wherein the first direction comprises a direction perpendicular to a direction of the optical axis, and the second direction comprises a direction perpendicular to both the direction of the optical axis and the first direction.

11. The optical system according to claim 10, wherein the cylindrical lens is a convex cylindrical lens, the convex cylindrical lens forms a convex surface in a Y-axis direction, the convex cylindrical lens comprises a plano-convex cylindrical lens or a biconvex cylindrical lens, and a convex surface of the plano-convex cylindrical lens is a surface facing away from the lens group, wherein the Y-axis is the first direction.

12. The optical system according to claim 11, wherein a radius of curvature R of a side surface of the convex cylindrical lens facing way from the lens group in the Y-axis direction, a Y-axis focal length Fy0 of the optical system, a Y-axis focal length Fy1 of the cylindrical lens, a Y-axis focal length Fy2 of the lens group, a distance d from a center of a side surface of the cylindrical lens closer to the lens group to a center of a side surface of a last lens in the lens group closer to the cylindrical lens on the optical axis of the optical system and an X-axis focal length Fx0 of the optical system, a maximum effective aperture D of the optical system, a distance L between a center of the free-form surface and a center of the image plane of the optical system, and an image height H corresponding to a maximal field-of-view of the optical system satisfy at least one of following conditions:
$$R / Fy 0 \leq - 5 ;$$
$$\vert R / Fy 0 \vert \geq 5 ;$$
$$0.005 \leq Fy 2 / ( Fy 1 * \sqrt{d} ) \leq 0.05 ;$$
$$10 \leq \vert Fy 1 / Fy 2 \vert \leq 90 ;$$
$$Fx 0 / Fy 0 \geq 1.002 ; and$$
$$8 \leq D * L / H \leq 20.$$

13. The optical system according to claim 2, wherein the optical system further comprises: a photosensitive component,
wherein the photosensitive component comprises a photosensitive chip having a photosensitive area, the photosensitive component is arranged on a side of an optical component farther away from the lens group, and the first direction is parallel to an extension direction of a long side of the photosensitive area of the photosensitive chip,
wherein a size of the photosensitive chip in the first direction is larger than a size of the photosensitive chip in the second direction, and the photosensitive chip is disposed on an image plane of the optical system, the image plane being disposed on a side of the optical element of the optical system facing away from the lens group.

14. The optical system according to claim 1, wherein the optical element comprises a microstructure array, and the microstructure array comprises a plurality of microstructures arranged in the first direction and the second direction; and
an optical parameter of the microstructure in the first direction satisfies a preset condition, such that the focal length of the optical system in the first direction is smaller than the focal length of the optical system in the second direction, and the optical parameter comprises a focal length and/or a radius of curvature,
wherein the microstructure array further comprises a substrate, and the substrate has a plurality of the microstructures arranged in an array on a side facing the lens group and/or a side facing away from the lens group.

15. The optical system according to claim 14, wherein in a direction of the optical axis of the lens group, the microstructure has a convex surface protruding in a direction facing away from a substrate; and
the preset condition comprises a focal length Fy1 of the microstructure in the first direction, a focal length Fy2 of the lens group in the first direction, an air spacing d between the lens group and the microstructure array, a radius of curvature R of the convex surface in the first direction, a focal length Fy0 of the optical system in the first direction, a focal length Fx0 of the optical system in the second direction, a maximum effective aperture D of the optical system, a distance L between a center of the free-form surface and a center of the image plane of the optical system, and an image height H corresponding to a maximal field-of-view of the optical system, satisfying at least one of following conditions:
$$1.1 \leq Fy 1 / Fy 2 \leq 6 ;$$
$$0.1 \leq Fy 2 / ( Fy 1 * SQRT ( d ) ) ) ;$$
$$\vert R / Fy 0 \vert \geq 0.5 ;$$
$$Fx 0 / Fy 0 \geq 1.01 ;$$
$$10 \leq D * L / H \leq 25 ; and$$
$$0.1 \leq Fy 2 / ( Fy 1 * SQRT ( d ) ) \leq 1.15 .$$

16. The optical system according to claim 14, wherein at least two of the microstructures in the plurality of the microstructures have different thicknesses along the direction of the optical axis.

17. The optical system according to claim 14, wherein a difference between a maximum thickness of the microstructures and a minimum thickness of the microstructures is not greater than 0.1 mm.

18. The optical system according to claim 1, wherein the focal length of the optical system in the first direction is smaller than the focal length of the optical system in the second direction.

19. The optical system according to claim 1, wherein a maximum effective aperture D of the optical system, a distance L between a center of the free-form surface and a center of the image plane of the optical system, an image height H corresponding to a maximal field-of-view of the optical system, a focal length F of the optical system and an entrance pupil diameter ENPD of the optical system, a total track length TTL of the optical system, and a maximal field-of-view FOV of the optical system satisfy at least one of:
$$5 \leq D * L / H \leq 35$$
$$1.1 \leq F / ENPD \leq 1.6 ;$$
$$0.37 \geq L / TTL \geq 0.12 ; and$$
$$TTL / H / FOV \leq 0.15 .$$

20. The optical system according to claim 1, wherein the optical element comprises a free-form surface lens or a convex cylindrical lens, wherein a focal length Fx0 of the optical system in the second direction, the focal length Fy0 in the first direction, the focal length Fy1 of the free-form surface lens in the first direction, a radius of curvature R of a side surface of the convex cylindrical lens facing away from the lens assembly in the first direction, the focal length Fx1 of the free-form lens along the second direction, a total track length TTL of the optical system, a sag SAGy of the free-form surface in the first direction, a sag SAGx of the free-form surface in the second direction and a distance L between a center of the free-form surface and a center of the image plane of the optical system, satisfy at least one of:
$$1.36 \geq Fx 0 / Fy 0 \geq 1.002 ;$$
$$0.7 \leq \vert Fy 1 / Fy 2 \vert \leq 0.1 ;$$
$$45 \leq R / Fy 0 \leq - 8 ;$$
$$1.003 \leq Fx 1 / Fy 1 \leq 1.055 ;$$
$$50 \leq TTL / [ ( SAGx + SAGy ) / 2 ] \leq 70 ; and$$
$$0.4 \leq L / Fx \leq 0.7 .$$

21. A LiDAR device, comprising:
a radar receiving end, the radar receiving end comprising an optical system and being configured to receive reflected light from a detected object,
wherein the optical system comprises:
a lens group, arranged sequentially along an optical axis from an object side to an image side; and
an optical element, disposed on a transmission optical path of the lens group, the optical element having different focal lengths in a first direction and a second direction;
wherein the first direction and the second direction have an included angle therebetween and are both perpendicular to the optical axis, and a focal length of the optical system in the first direction is different from a focal length of the optical system in the second direction,
wherein a light spot formed on an imaging plane by external light sequentially passing through the lens group and the optical element is a strip-shaped light spot extending in the first direction.
